(19) United States
(12) Patent Application Publication
(10) Pub. No.: US 2015/0170477 A1
(43) Pub. Date: Jun. 18, 2015

(54) ELECTRONIC GAMING DEVICE WITH HOT SPOT FUNCTIONALITY

(71) Applicants: Roman Souza, Johns Creek, GA (US); Simone Leo, Atlanta, GA (US); Eric Boese, Decatur, GA (US)

(72) Inventors: Roman Souza, Johns Creek, GA (US); Simone Leo, Atlanta, GA (US); Eric Boese, Decatur, GA (US)

(73) Assignee: CADILLAC JACK, DULUTH, GA (US)

(21) Appl. No.: 14/109,504

(22) Filed: Dec. 17, 2013

(51) Int. Cl. G07F 17/34

(52) U.S. Cl. CPC G07F 17/34

(57) ABSTRACT

Examples disclosed herein relate to an electronic gaming device including a memory, a processor, and a plurality of reels. The memory may include one or more hot spot feature structures. The processor may generate one or more symbols to be located in the one or more areas. The processor may generate one or more hot spot symbols to be located in one or more reels. The processor may generate one or more awards based on one or more hot spot symbol locations.

### FIELD

The subject matter disclosed herein relates to an electronic gaming device. More specifically, the disclosure relates to providing one or more hot spot functionalities on a gaming device.

### INFORMATION

The gaming industry has numerous casinos located both worldwide and in the United States. A client of a casino or other gaming entity can gamble via various games of chance. For example, craps, roulette, baccarat, blackjack, and electronic games (e.g., a slot machine) where a person may gamble on an outcome.

Paylines of an electronic gaming device (e.g., a slot machine) are utilized to determine when predetermined winning symbol combinations are aligned in a predetermined pattern to form a winning combination. A winning event occurs when the player successfully matches the predetermined winning symbols in one of the predetermined patterns.

A player's entertainment while playing one or more games may be enhanced by utilizing one or more hot spot functionalities on the gaming device. By increasing the player's entertainment level, the player's enjoyment of the game may be enhanced, which may increase a player's game playing period.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of the electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5A is an illustration of hot spot game play on a gaming device, according to one embodiment.

FIG. 5B is another illustration of hot spot game play on a gaming device, according to one embodiment.

FIG. 5C is another illustration of hot spot game play on a gaming device, according to one embodiment.

FIG. 5D is another illustration of hot spot game play on a gaming device, according to one embodiment.

FIG. 5E is another illustration of hot spot game play on a gaming device, according to one embodiment.

FIG. 5F is another illustration of hot spot game play on a gaming device, according to one embodiment.

FIG. 5G is another illustration of hot spot game play on a gaming device, according to one embodiment.

FIG. 6A is another illustration of hot spot game play on a gaming device, according to one embodiment.

FIG. 6B is another illustration of hot spot game play on a gaming device, according to one embodiment.

FIG. 6C is another illustration of hot spot game play on a gaming device, according to one embodiment.

FIG. 6D is another illustration of hot spot game play on a gaming device, according to one embodiment.

FIG. 6E is another illustration of hot spot game play on a gaming device, according to one embodiment.

FIG. 6F is another illustration of hot spot game play on a gaming device, according to one embodiment.

FIG. 6G is another illustration of hot spot game play on a gaming device, according to one embodiment.

FIG. 6H is another illustration of hot spot game play on a gaming device, according to one embodiment.

FIG. 7A is another illustration of hot spot game play on a gaming device, according to one embodiment.

FIG. 7B is another illustration of hot spot game play on a gaming device, according to one embodiment.

FIG. 7C is another illustration of hot spot game play on a gaming device, according to one embodiment.

FIG. 8 is a game play flow diagram, according to one embodiment

FIG. 9 is a game play flow diagram, according to one embodiment.

FIG. 10 is a flow diagram for game play, according to one embodiment.

FIG. 11 is a flow diagram for game play, according to one embodiment.

FIG. 12 is a flow diagram for game play, according to one embodiment.

### DETAILED DESCRIPTION

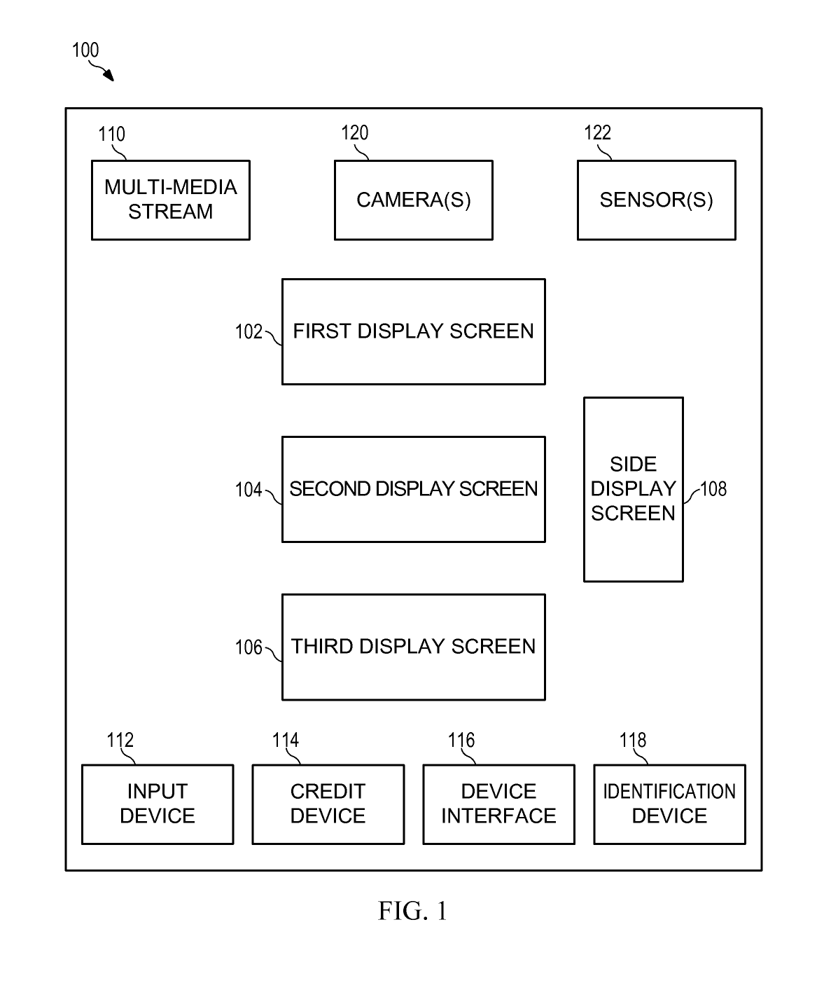

FIG. 1 is an illustration of an electronic gaming device 100. Electronic gaming device 100 may include a multi-media stream 110, a first display screen 102, a second display screen 104, a third display screen 106, a side display screen 108, an input device 112, a credit device 114, a device interface 116, and an identification device 118. Electronic gaming device 100 may display one, two, a few, or a plurality of multi-media streams 110, which may be obtained from one or more gaming tables, one or more electronic gaming devices, a central server, a video server, a music server, an advertising server, another data source, and/or any combination thereof.

Multi-media streams may be obtained for an entertainment event, a wagering event, a promotional event, a promotional offering, an advertisement, a sporting event, any other event, and/or any combination thereof. For example, the entertainment event may be a concert, a show, a television program, a movie, an Internet event, and/or any combination thereof. In another example, the wagering event may be a poker tournament, a horse race, a car race, and/or any combination thereof. The advertisement may be an advertisement for a casino, a restaurant, a shop, any other entity, and/or any combination thereof. The sporting event may be a football game, a baseball game, a hockey game, a basketball game, any other sporting event, and/or any combination thereof. These multi-media streams may be utilized in combination with the gaming table video streams.

Input device 112 may be mechanical buttons, electronic buttons, mechanical switches, electronic switches, optical switches, a slot pull handle, a keyboard, a keypad, a touch screen, a gesture screen, a joystick, a pointing device (e.g., a mouse), a virtual (on-screen) keyboard, a virtual (on-screen) keypad, biometric sensor, or any combination thereof. Input device 112 may be utilized to select one or more hot spot gaming options, to make a wager, to control any object, to select one or more pattern gaming options, to obtain data relating to historical payouts, to select a row and/or column to move, to select a row area to move, to select a column area to move, to select a symbol (or image) to move, to modify electronic gaming device 100 (e.g., change sound level, configuration, font, language, etc.), to select a movie or song, to select live multi-media streams, to request services (e.g., drinks, slot attendant, manager, etc.), to select two-dimensional (“2D”) game play, to select three-dimensional (“3D”) game play, to select both two-dimensional and three-dimensional game play, to change the orientation of games in a three-dimensional space, to move a symbol (e.g., wild, multiplier, etc.), and/or any combination thereof. These selections may occur via any other input device (e.g., a touch screen, voice commands, etc.). Input device 112 may be any control panel.

Credit device 114 may be utilized to collect monies and distribute monies (e.g., cash, vouchers, etc.). Credit device 114 may interface with a mobile device to electronically transmit money and/or credits. Credit device 114 may interface with a player's card to exchange player points.

Device interface 116 may be utilized to interface electronic gaming device 100 to a bonus game device, a local area progressive controller, a wide area progressive controller, a progressive sign controller, a peripheral display device, signage, a promotional device, network components, a local network, a wide area network, remote access equipment, a slot monitoring system, a slot player tracking system, the Internet, a server, and/or any combination thereof.

Device interface 116 may be utilized to connect a player to electronic gaming device 100 through a mobile device, card, keypad, identification device 118, and/or any combination thereof. Device interface 116 may include a docking station by which a mobile device is plugged into electronic gaming machine 100. Device interface 116 may include an over the air connection by which a mobile device is connected to electronic gaming machine 100 (e.g., Bluetooth, Near Field technology, and/or Wi-Fi technology). Device interface 116 may include a connection to identification device 118.

Identification device 118 may be utilized to determine an identity of a player. Based on information obtained by identification device 118, electronic gaming device 100 may be reconfigured. For example, the language, sound level, music, placement of multi-media streams, one or more game functionalities (e.g., game type 1, game type 2, game type 3, etc.) may be presented, a hot spot gaming option may be presented, a repeat payline gaming option may be presented, a pattern gaming option may be presented, historical gaming data may be presented, a row rearrangement option may be presented, a column rearrangement option may be presented, a row area rearrangement option may be presented, a column area rearrangement option may be presented, a two-dimensional gaming option may be presented, a three-dimensional gaming option may be presented, and/or the placement of gaming options may be modified based on player preference data. For example, the player may only want to play games that include hot spot gaming options only. Therefore, only games which include hot spot gaming options would be presented to the player. In another example, the player may only want to play games that include historical information relating to game play. Therefore, only games which include historical gaming data would be presented to the player. These examples may be combined.

Identification device 118 may utilize biometrics (e.g., thumb print, retinal scan, or other biometric). Identification device 118 may include a card entry slot into input device 112. Identification device 118 may include a keypad with an assigned pin number for verification. Identification device 118 may include multiple layers of identification for added security. For example, a player could be required to enter a player tracking card, and/or a pin number, and/or a thumb print, and/or any combination thereof. Based on information obtained by identification device 118, electronic gaming device 100 may be reconfigured. For example, the language, sound level, music, placement of video streams, placement of images, and the placement of gaming options utilized may be modified based on a player's preference data. For example, a player may have selected baseball under the sporting event preferences; electronic gaming device 100 will then automatically display the current baseball game onto side display screen 108 and/or an alternate display screen as set in the player's options.

First display screen 102 may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology. First display screen 102 may be used for displaying primary games or secondary (bonus) games, to display one or more warnings relating to one or more audio devices, one or more display devices, one or more electrical wires, one or more springs, one or more motors, one or more adjustable devices, and/or one or more sensors, advertising, player attractions, electronic gaming device 100 configuration parameters and settings, game history, accounting meters, events, alarms, and/or any combination thereof. Second display screen 104, third display screen 106, side display screen 108, and any other screens may utilize the same technology as first display screen 102 and/or any combination of technologies.

First display screen 102 may also be virtually combined with second display screen 104. Likewise second display screen 104 may also be virtually combined with third display screen 106. First display screen 102 may be virtually combined with both second display screen 104 and third display screen 106. Any combination thereof may be formed.

For example, a single large image could be partially displayed on second display screen 104 and partially displayed on third display screen 106, so that when both display screens are put together they complete one image. Electronic gaming device 100 may stream or play prerecorded multi-media data, which may be displayed on any display combination.

One or more cameras 120 and/or one or more sensors 122 may be utilized as one or more depth image sensing devices, which may be located in various locations, including but not limited to, above the base display, above second display, in one or more locations on gaming cabinet front, on a side of the gaming cabinet other than gaming cabinet front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

Electronic gaming device 100 may include at least one display device. Electronic gaming device 100 may include a base display and/or a second display. In one embodiment, base display may be the primary display for a first game. In another embodiment, second display may be the primary display for a second and/or bonus game. For example, base display may display: a reel-type video slot game; and upon a bonus game triggering condition; second display may display a bonus game; and upon a hot spot game feature triggering event; first and/or second display may display a hot spot game feature.

In one embodiment, base display and second display may display separate portions of a common image. For example, second display may display a top portion of a wheel spinning while base display may display the bottom portion of the same wheel spinning.

Electronic gaming device 100 may also include one or more speakers. In one embodiment, one or more speakers may work in a synchronized manner to provide a surround sound effect. For example, as an object is displayed moving across base display from left to right, one or more speakers may produce sound in such a manner as to create an audible sense of similar left to right movement. In another embodiment, one or more speakers may work asynchronously. In a further embodiment, a first speaker may produce sounds associated with a first symbol appearing in a play of a game, and a second speaker may produce sounds associated with a second symbol appearing in a play of the game.

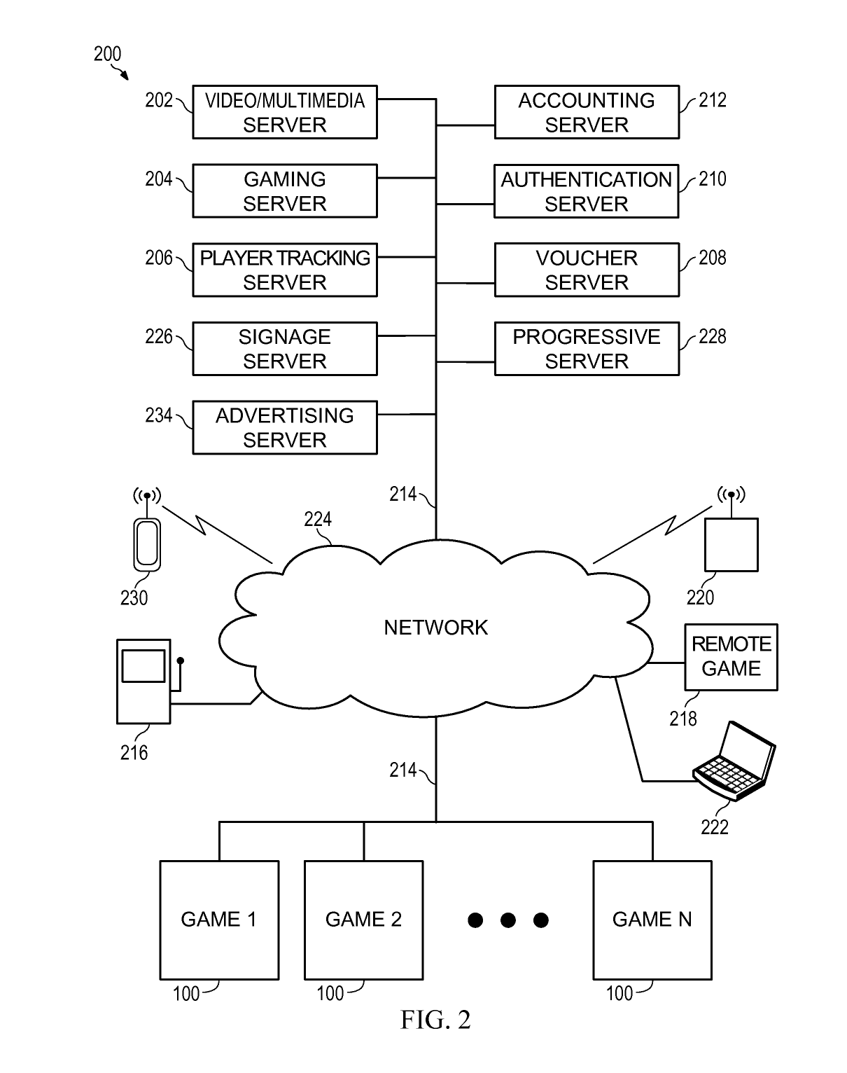

In FIG. 2, an electronic gaming system 200 is shown. Electronic gaming system 200 may include a video/multimedia server 202, a gaming server 204, a player tracking server 206, a voucher server 208, an authentication server 210, and an accounting server 212.

Electronic gaming system 200 may include video/multimedia server 202, which may be coupled to network 224 via a network link 214. Network 224 may be the Internet, a private network, and/or a network cloud. One or more video streams may be received at video/multimedia server 202 from other electronic gaming devices 100. Video/multimedia server 202 may transmit one or more of these video streams to a mobile phone 230, electronic gaming device 100, a remote electronic gaming device at a different location in the same property 216, a remote electronic gaming device at a different location 218, a laptop 222, and/or any other remote electronic device 220. Video/multimedia server 202 may transmit these video streams via network link 214 and/or network 224.

For example, a remote gaming device at the same location may be utilized at a casino with multiple casino floors, a casino that allows wagering activities to take place from the hotel room, a casino that may allow wagering activities to take place from the pool area, etc. In another example, the remote devices may be at another location via a progressive link to another casino, and/or a link within a casino corporation that owns numerous casinos (e.g., MGM, Caesars, etc.).

Gaming server 204 may generate gaming outcomes. Gaming server 204 may provide electronic gaming device 100 with game play content. Gaming server 204 may provide electronic gaming device 100 with game play math and/or outcomes. Gaming server 204 may provide one or more of: a hot spot game feature functionality; a hot spot game feature evaluation functionality; a payout functionality; a base and/or bonus game play functionality; a base and/or bonus game play evaluation functionality, other game functionality, and/or any other virtual game functionality.

Player tracking server 206 may track a player's betting activity, a player's preferences (e.g., language, font, sound level, drinks, etc.). Based on data obtained by player tracking server 206, a player may be eligible for gaming rewards (e.g., free play), promotions, and/or other awards (e.g., complimentary food, drinks, lodging, concerts, etc.).

Voucher server 208 may generate a voucher, which may include data relating to gaming. Further, the voucher may include payline structure option selections. In addition, the voucher may include game play data (or similar game play data), repeat payline data, pattern data, historical payout data, column data, row data, and/or symbols that were modified.

Authentication server 210 may determine the validity of vouchers, player's identity, and/or an outcome for a gaming event.

Accounting server 212 may compile, track, and/or monitor cash flows, voucher transactions, winning vouchers, losing vouchers, and/or other transaction data. Transaction data may include the number of wagers, the size of these wagers, the date and time for these wagers, the identity of the players making these wagers, and/or the frequency of the wagers. Accounting server 212 may generate tax information relating to these wagers. Accounting server 212 may generate profit/loss reports for players' tracked outcomes.

Network connection 214 may be used for communication between dedicated servers, thin clients, thick clients, back-office accounting systems, etc.

Laptop computer 222 and/or any other electronic devices (e.g., mobile phone 230, electronic gaming device 100, etc.) may be used for downloading new gaming device applications or gaming device related firmware through remote access.

Laptop computer 222 and/or any other electronic device (e.g., mobile phone 230, electronic gaming device 100, etc.) may be used for uploading accounting information (e.g., cashable credits, non-cashable credits, coin in, coin out, bill in, voucher in, voucher out, etc.).

Network 224 may be a local area network, a casino premises network, a wide area network, a virtual private network, an enterprise private network, the Internet, or any combination thereof. Hardware components, such as network interface cards, repeaters and hubs, bridges, switches, routers, firewalls, or any combination thereof may also be part of network 224.

A statistics server may be used to maintain data relating to historical game play for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

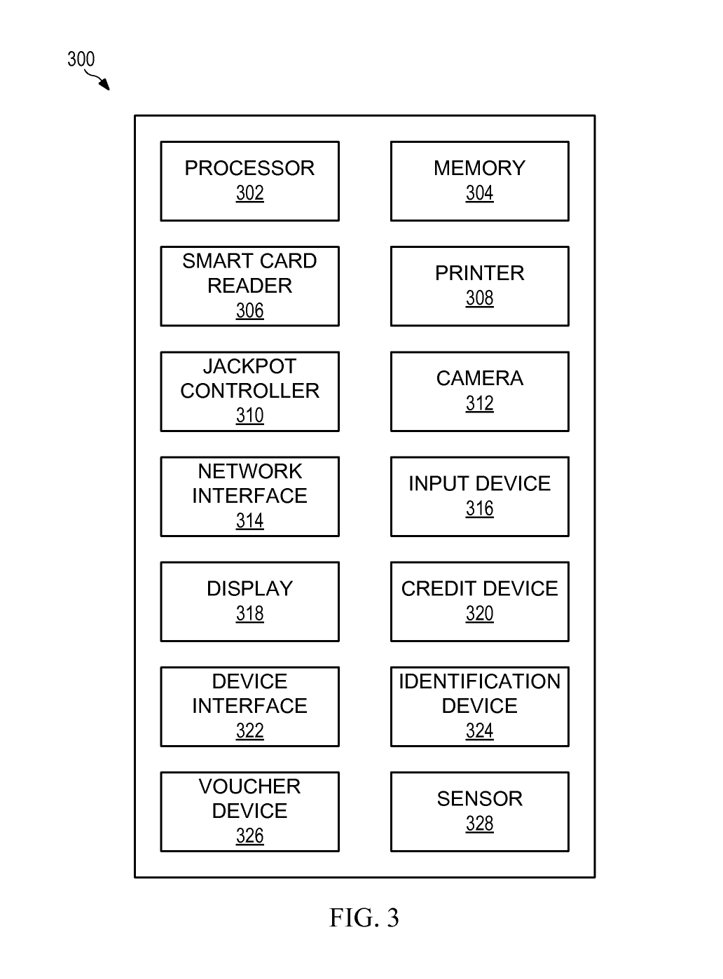

FIG. 3 shows a block diagram 300 of electronic gaming device 100. Electronic gaming device 100 may include a processor 302, a memory 304, a smart card reader 306, a printer 308, a jackpot controller 310, a camera 312, a network interface 314, an input device 316, a display 318, a credit device 320, a device interface 322, an identification device 324, and a voucher device 326.

Processor 302 may execute program instructions of memory 304 and use memory 304 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 304 to access a player's mobile device through device interface 322 to display contents onto display 318. Processor 302 may generate a voucher based on a wager confirmation, which may be received by an input device, a server, a mobile device, and/or any combination thereof. A voucher device may generate, print, transmit, or receive a voucher. Memory 304 may include communication interfaces for communicating with electronic gaming device 100, electronic gaming system 200, and user interfaces to enable communication with all gaming elements. For example, the information stored on memory 304 may be printed out onto a voucher by printer 308. Videos or pictures captured by camera 312 may be saved and stored on memory 304. Memory 304 may include a confirmation module, which may authenticate a value of a voucher and/or the validity of the voucher. Processor 302 may determine the value of the voucher based on generated voucher data and data in the confirmation module. Electronic gaming device 100 may include a player preference input device. The player preference input device may modify a game configuration. The modification may be based on data from the identification device.

Memory 304 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 304 may also be volatile semiconductor memory such as, dynamic random access memory (“DRAM”), static random access memory (“SRAM”), and/or any combination thereof.

Memory 304 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 304 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Memory 304 may be used to store the read-only paytable information for which symbol combinations on a given payline that result in a win (e.g., payout) which are established for games of chance, such as slot games and video poker.

Memory 304 may be used to store accounting information (e.g., cashable electronic promotion in, non-cashable electronic promotion out, coin in, coin out, bill in, voucher in, voucher out, electronic funds transfer in, etc.).

Memory 304 may be used to record error conditions on an electronic gaming device 100, such as door open, coin jam, ticket print failure, ticket (e.g., paper) jam, program error, reel tilt, etc., and/or any combination thereof.

Memory 304 may also be used to record the complete history for the most recent game played, plus some number of prior games as may be determined by the regulating authority.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 324 to verify the identity of a player.

Printer 308 may be used for printing slot machine payout receipts, slot machine wagering vouchers, non-gaming coupons, slot machine coupons (e.g., a wagering instrument with a fixed waging value that can only be used for non-cashable credits), drink tokens, comps, and/or any combination thereof.

Electronic gaming device 100 may include a jackpot controller 310, which may allow electronic gaming device 100 to interface with other electronic gaming devices either directly or through electronic gaming system 200 to accumulate a shared jackpot.

Camera 312 may allow electronic gaming device 100 to take images of a player or a player's surroundings. For example, when a player sits down at the machine his or her picture may be taken to include his or her image into the game play. A picture of a player may be an actual image as taken by camera 312. A picture of a player may be a computerized caricature of the image taken by camera 312. The image obtained by camera 312 may be used in connection with identification device 324 using facial recognition. Camera 312 may allow electronic gaming device 100 to record video. The video may be stored on memory 304 or stored remotely via electronic gaming system 200. Videos obtained by camera 312 may then be used as part of game play, or may be used for security purposes. For example, a camera located on electronic gaming device 100 may capture videos of a potential illegal activity (e.g., tampering with the machine, crime in the vicinity, underage players, etc.).

Network interface 314 may allow electronic gaming device 100 to communicate with video/multimedia server 202, gaming server 204, player tracking server 206, voucher server 208, authentication server 210, and/or accounting server 212.

Input device 316 may be mechanical buttons, electronic buttons, a touch screen, and/or any combination thereof. Input device 316 may be utilized to make a wager, to select one or more game elements, to select one or more gaming options, to make an offer to buy or sell a voucher, to determine a voucher's worth, to cash in a voucher, to modify electronic gaming device 100 (e.g., change sound level, configuration, font, language, etc.), to modify one of one or more audio devices, one or more display devices, one or more electrical wires, one or more springs, one or more motors, one or more adjustable devices, and/or one or more sensors, to select a movie or music, to select live video streams (e.g., sporting event 1, sporting event 2, sporting event 3), to request services (e.g., drinks, manager, etc.), and/or any combination thereof.

Display 318 may show video streams from one or more content sources. Display 318 may encompass first display screen 102, second display screen 104, third display screen 106, side display screen 108, and/or another screen used for displaying video content.

Credit device 320 may be utilized to collect monies and distribute monies (e.g., cash, vouchers, etc.). Credit device 320 may interface with processor 302 to allow game play to take place. Processor 302 may determine any payouts, display configurations, animation, and/or any other functions associated with game play. Credit device 320 may interface with display 318 to display the amount of available credits for the player to use for wagering purposes. Credit device 320 may interface via device interface 322 with a mobile device to electronically transmit money and/or credits. Credit device 320 may interface with a player's pre-established account, which may be stored on electronic gaming system 200, to electronically transmit money and/or credit. For example, a player may have a credit card or other mag-stripe card on file with the location for which money and/or credits can be directly applied when the player is done. Credit device 320 may interface with a player's card to exchange player points.

Electronic gaming device 100 may include a device interface 322 that a user may employ with his or her mobile device (e.g., smart phone) to receive information from and/or transmit information to electronic gaming device 100 (e.g., watch a movie, listen to music, obtain verbal betting options, verify identification, transmit credits, etc.).

Identification device 324 may be utilized to allow electronic gaming device 100 to determine an identity of a player. Based on information obtained by identification device 324, electronic gaming device 100 may be reconfigured. For example, the language, sound level, music, placement of video streams, placement of images, placement of gaming options, and/or the tables utilized may be modified based on player preference data.

For example, a player may have selected a specific baseball team (e.g., Atlanta Braves) under the sporting event preferences, the electronic gaming device 100 will then automatically (or via player input) display the current baseball game (e.g., Atlanta Braves vs. Philadelphia Phillies) onto side display screen 108 and/or an alternate display screen as set in the player's options.

A voucher device 326 may generate, print, transmit, or receive a voucher. The voucher may represent a wagering option, a wagering structure, a wagering timeline, a value of wager, a payout potential, a payout, and/or any other wagering data. A voucher may represent an award, which may be used at other locations inside of the gaming establishment. For example, the voucher may be a coupon for the local buffet or a concert ticket.

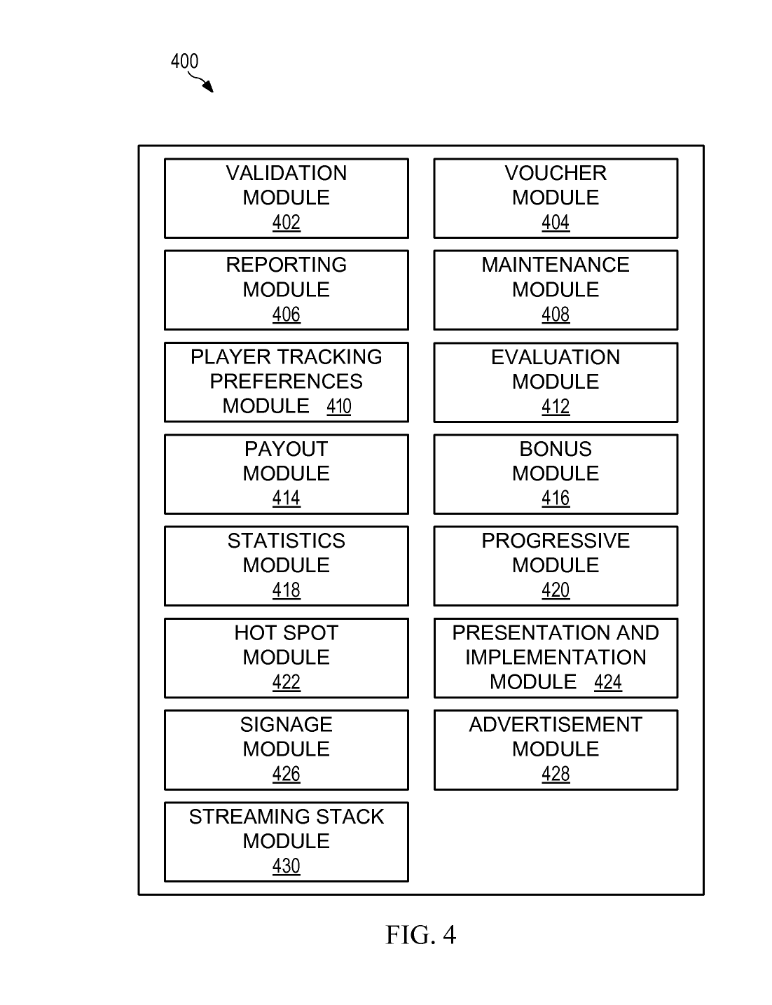

FIG. 4 shows a block diagram of memory 304, which includes various modules. Memory 304 may include a validation module 402, a voucher module 404, a reporting module 406, a maintenance module 408, a player tracking preferences module 410, an evaluation module 412, a payout module 414, a bonus module 416, a statics module 418, a progressive module 420, a hot spot module 422, a hot spot symbol generation module, a drawing module, a presentation and implementation module 424, an animation module, a hot spot evaluation module, a gesturing module, a scatter module, a wild module, a hot spot wild module, a hot spot scatter module, a hot spot symbol module, a mystery symbol module, a sensor module, a scene module, a sensor and scene evaluation module, a sensor and scene output module, a reference models module, an audio module, an audio device adjustment module, a display device adjustment module, a signage module 426, an advertisement module 428, and/or a streaming stack module 430. In one example, hot spot module 422 may include hot spot symbol generation module, drawing module, presentation and implementation module 424, animation module, hot spot evaluation module, hot spot wild module, hot spot scatter module, hot spot symbol module, and/or streaming stack module 430.

Validation module 402 may utilize data received from voucher device 326 to confirm the validity of the voucher.

Voucher module 404 may store data relating to generated vouchers, redeemed vouchers, bought vouchers, and/or sold vouchers.

Reporting module 406 may generate reports related to a performance of electronic gaming device 100, electronic gaming system 200, video streams, gaming objects, credit device 114, and/or identification device 118.

Maintenance module 408 may track any maintenance that is implemented on electronic gaming device 100 and/or electronic gaming system 200. Maintenance module 408 may schedule preventative maintenance and/or request a service call based on a device error.

Player tracking preferences module 410 may compile and track data associated with a player's preferences.

Animation module may generate, compile, transmit, and/or store one or more animations and/or presentations based on one or more scene data, one or more scenes, one or more reference models, one or more game play data, one or more player profiles, and/or any combination thereof.

Hot spot symbol generation module may generate, compile, transmit, display, and/or store one or more hot spot symbols which may be utilized on one or more reels and/or one or more screens.

Drawing module may generate, draw, compile, transmit, display, and/or store one or more hot spot symbols which may be utilized on one or more reels and/or one or more screens.

Presentation and implementation module 424 may generate, transmit, compile, implement, and/or store one or more presentations.

Hot spot module 422 may generate, compile, transmit, display, and/or store one or more hot spot actions which may be utilized on one or more reels and/or one or more screens.

Animation module may generate, compile, transmit, display, and/or store one or more animation images and/or data which may be utilized on one or more reels and/or one or more screens.

Hot spot evaluation module may evaluate one or more outcomes from one or more hot spot games, hot spot functions, hot spot actions, hot spot selections, and/or hot spot options.

Evaluation module 412 may evaluate one or more outcomes for one or more events relating to game play.

Gesturing module may generate, compile, transmit, display, store, evaluate, and/or implement one or more actions based on obtained gesturing data.

Scatter module may generate a scatter game, evaluate the results of the scatter game, trigger scatter game presentations, generate scatter game payouts, and/or display any data relating to the scatter game.

Wild module may generate a wild game, evaluate the results of the wild game, trigger wild game presentations, generate wild game payouts, and/or display any data relating to the wild game. Further, wild module 428 may determine one or more outcomes of one or more interactions (e.g., collisions of one or more symbols).

Hot spot wild module may generate, compile, transmit, display, and/or store one or more hot spot wild actions which may be utilized on one or more reels and/or one or more screens.

Hot spot scatter module may generate, compile, transmit, display, and/or store one or more hot spot scatter actions which may be utilized on one or more reels and/or one or more screens.

Hot spot symbol module may generate, compile, transmit, display, and/or store one or more hot spot symbol actions which may be utilized on one or more reels and/or one or more screens.

Mystery symbol module may generate, compile, transmit, display, and/or store one or more mystery symbol actions which may be utilized on one or more reels and/or one or more screens.

Payout module 414 may determine one or more payouts which may relate to one or more inputs received from the player, electronic gaming device 100, and/or electronic gaming system 200.

Sensor module may generate, compile, transmit, and/or store any data relating to one or more scene data, one or more scene, and/or any other sensor data. This data may include one or more gestures (e.g., body movement made by one or more players).

Scene module may generate, compile, transmit, and/or store on one or more scene data, one or more scenes, one or more reference models, one or more game play data, one or more player profiles, and/or any combination thereof.

Sensor and scene evaluation module may evaluate any data stored on, transmitted to, and/or transmitted from sensor module and scene module. Sensor and scene evaluation module may obtain data including one or more gestures (e.g., body movement made by one or more players) from sensor module and compare this data to one or more body reference models, body part reference models, device reference models, gaming device reference models, floor plan reference models, and/or any other reference models from reference models module to determine one or more actions.

Sensor and scene output module may evaluate the combined output of sensor module and scene module.

Reference models module may generate, compile, transmit, and/or store one or more body reference models, body part reference models, device reference models, gaming device reference models, floor plan reference models, and/or any other reference models which can be utilized by any of the other modules.

Audio module may generate, compile, transmit, and/or store one or more audio structures, sound wave configurations, and/or any other audio data.

Audio device adjustment module may adjust one or more audio devices. These devices may be adjusted physically (e.g., moved) and/or by changing one or more device characteristics.

Display device adjustment module may adjust one or more display devices. These devices may be adjusted physically (e.g., moved) and/or by changing one or more device characteristics.

Bonus module 416 may generate a bonus game, evaluate the results of the bonus game, trigger bonus game presentations, generate bonus game payouts, and/or display any data relating to the bonus game.

Statistics module 418 may be used to maintain data relating to historical game play for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

Progressive module 420 may generate, transmit, compile, and/or store one or more data points relating to one or more progressives and/or subscription progressives (e.g., a progressive a player selects and pays to enter).

Signage module 426 may generate, transmit, compile, initiate, and/or store one or more presentations for one or more signs.

Advertisement module 428 may generate, transmit, compile, present, implement, initiate, and/or store one or more advertisements.

Streaming stack module 430 may generate, transmit, compile, present, implement, initiate, and/or store one or more streaming stacks and/or streaming stack data and/or streaming stack presentations.

Installation verification module may verify the installation parameters on one or more of audio devices, one or more display devices, one or more electrical wires, one or more springs, one or more motors, one or more adjustable devices, and/or one or more sensors to one or more reference data points. Installation verification module may generate a warning when the data points are outside of a specific parameter range. One or more warnings may be transmitted to an external device, a server, a mobile device, and/or a warning display on electronic gaming device 100 based on the verification data.

Locking module may control the locking mechanism for one or more audio devices, one or more display devices, one or more electrical wires, one or more springs, one or more motors, one or more adjustable devices, and/or one or more sensors. Locking module may control any locking mechanism for electronic gaming device 100. Locking module may generate a warning when a locking data point is outside of a specific parameter. These warnings may be transmitted to an external device, a server, a mobile device, and/or a warning display on electronic gaming device 100.

It should be noted that one or more modules may be combined into one module. Further, there may be one evaluation module where the determined payout does not depend on whether there were any wild symbols, scatter symbols, hot spot based game play, and/or any other specific symbols. Further, any module, device, and/or logic function in electronic gaming device 100 may be present in electronic gaming system 200. In addition, any module, device, and/or logic function in electronic gaming system 200 may be present in electronic gaming device 100.

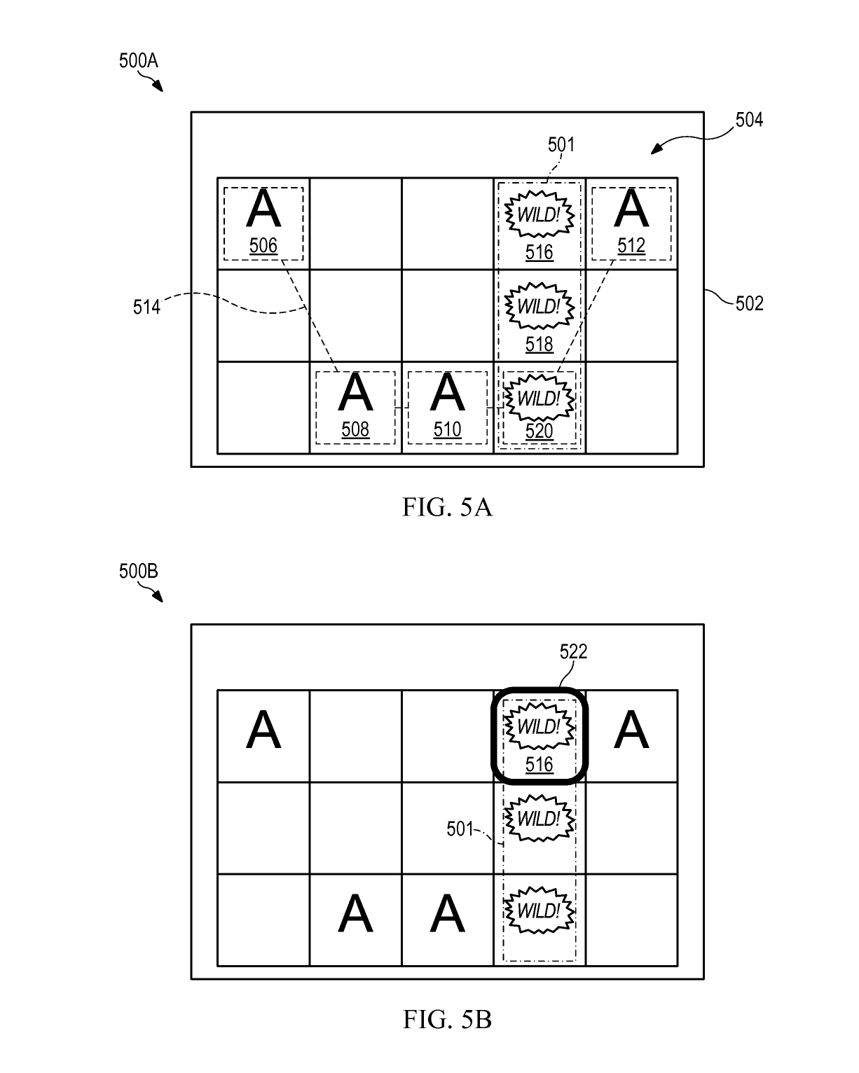

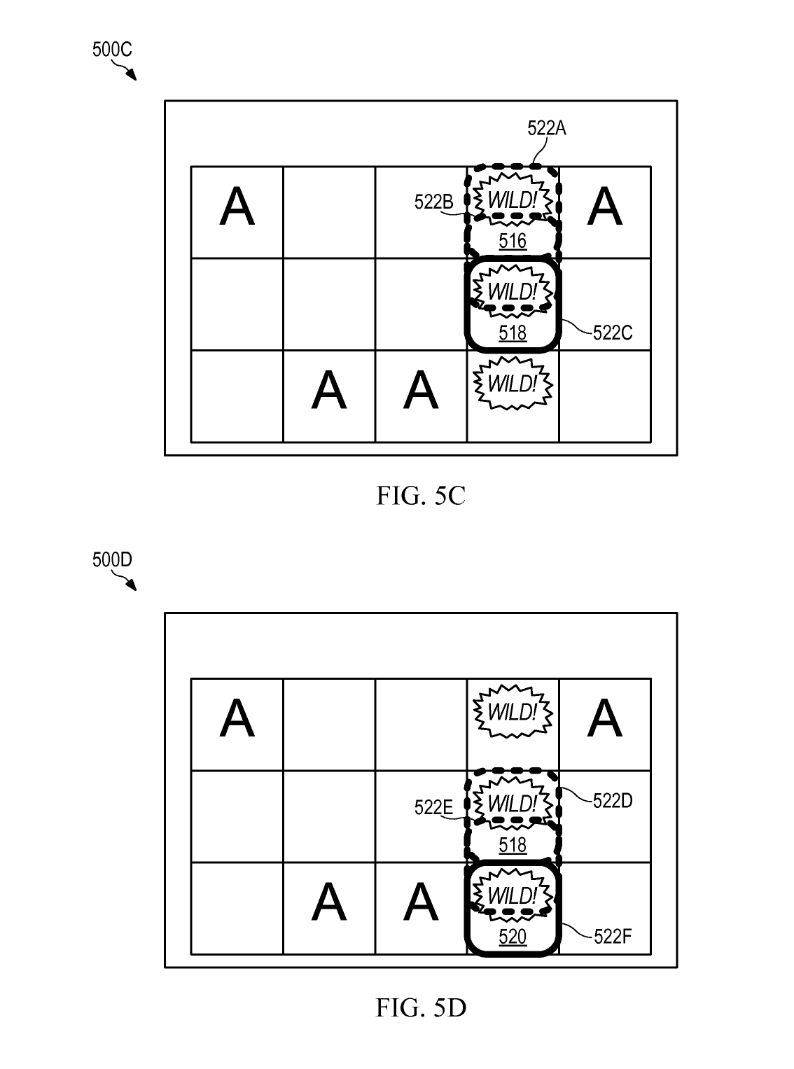

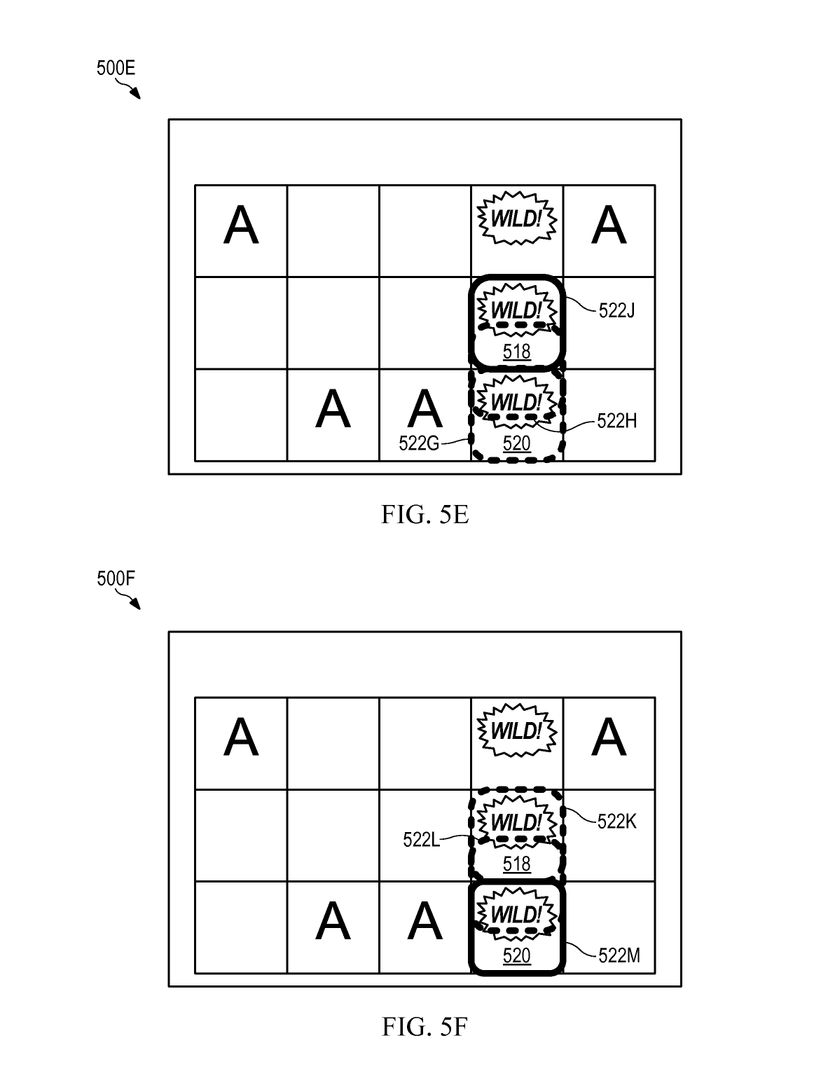

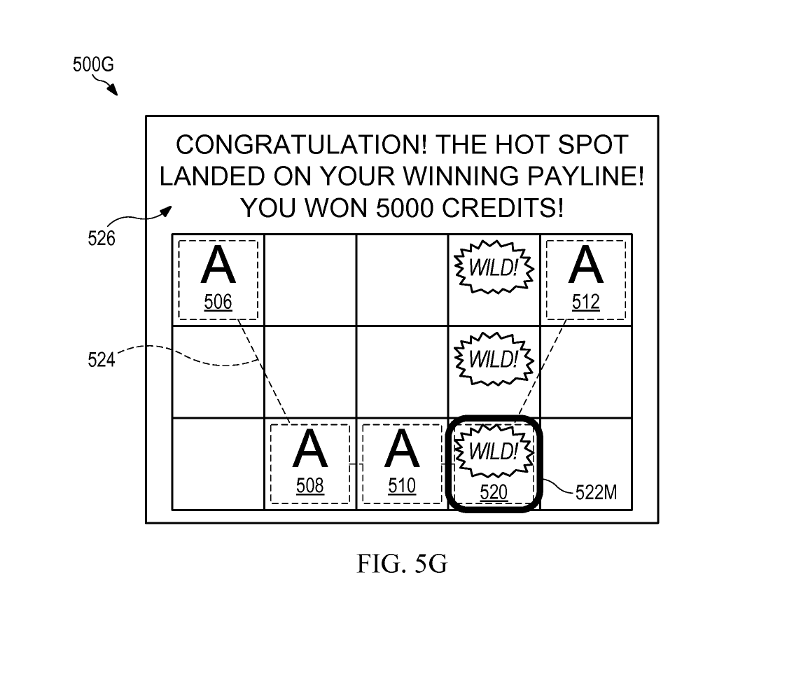

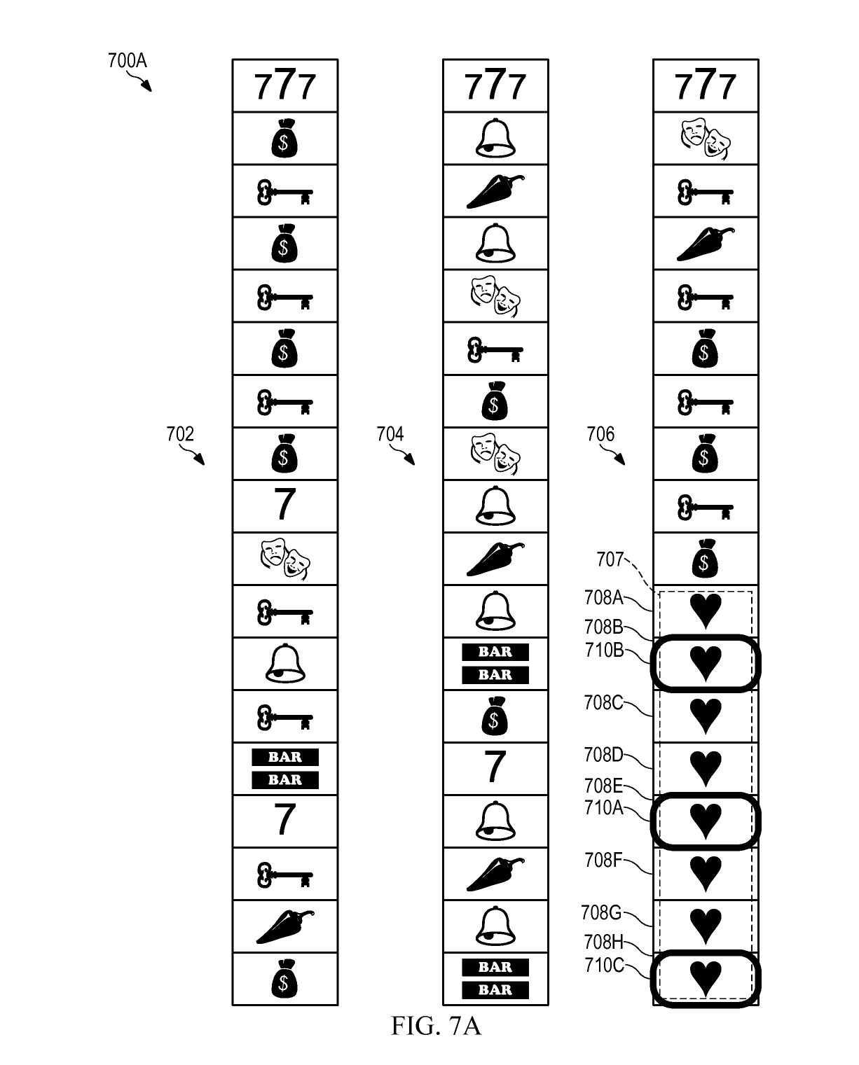

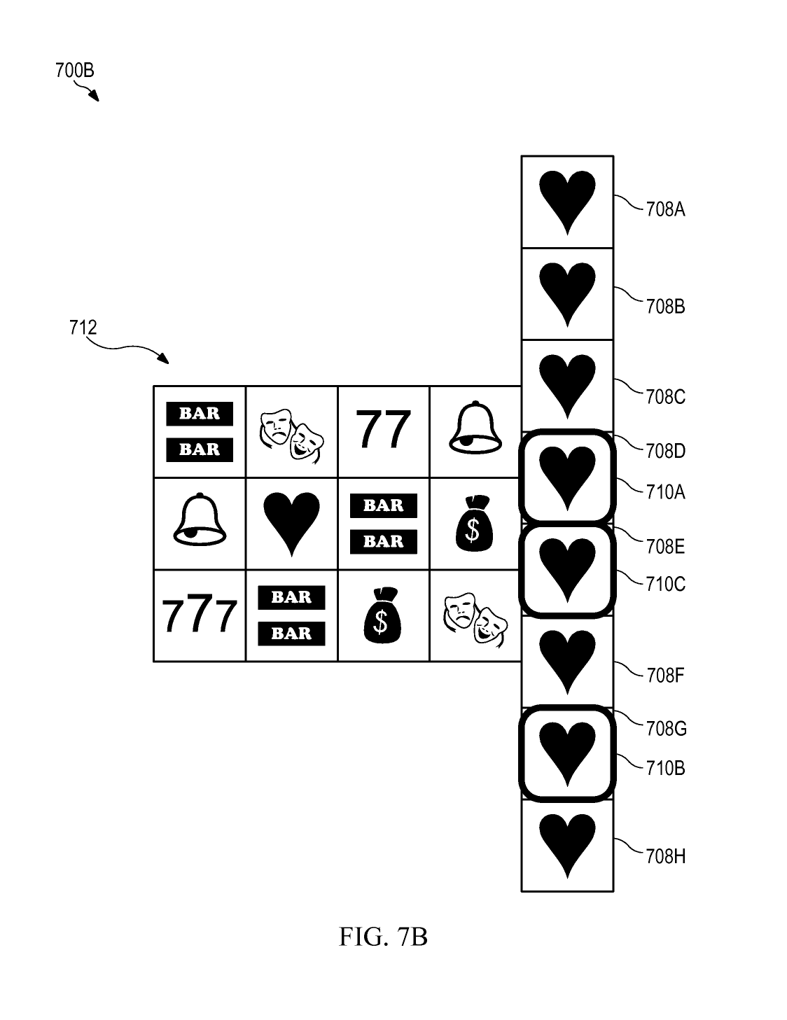

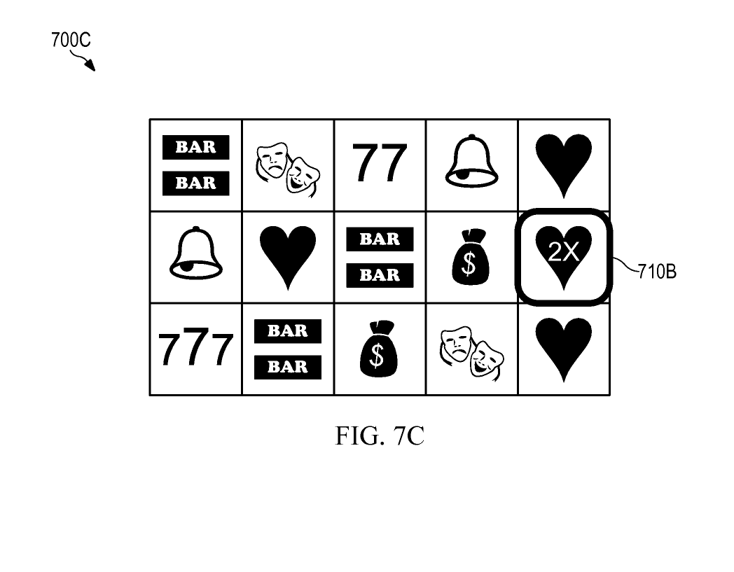

In FIG. 5A, an illustration of hot spot game play on a gaming device is shown, according to one embodiment. In one example, a first image 500A may include a display screen 502, one or more reels 504, a first winning payline symbol 506, a second winning payline symbol 508, a third winning payline symbol 510, a fourth winning payline symbol 512, a first payline 514, a first stacked wild symbol 516, a second stacked wild symbol 518, and a third stacked wild symbol 520. In this example, first payline 514 is a winning payline because the four aces (e.g., first winning payline symbol 506, second winning payline symbol 508, third winning payline symbol 510, and fourth winning payline symbol 512) are matched up with a wild symbol (e.g., third stacked wild 520) to form a winning payout combination of 5 aces because the wild can be utilized as an ace (and/or any other symbol except in some situations a wild cannot be utilized as a scatter symbol). In this example, a stacked wild 501 includes at least 3 wild symbols, however, any number (e.g., 1-N) of symbols may be utilized in a stacked configuration (see FIGS. 7A-7C).

In FIG. 5B, another illustration of hot spot game play on a gaming device is shown, according to one embodiment. A second image 500B may include a hot spot symbol 522 randomly being generated onto stacked wild 501. In this example, the hot spot symbol 522 may have been generated by a random number generator, a predetermined pattern, and/or any other dynamic method. Further, hot spot symbol 522 may have been located on one or more stacked symbol areas (e.g., stacked wild 501, stacked aces, stacked kings, stacked bars, stacked special symbol, etc.).

In one example shown in FIG. 5C, once the hot spot symbol 522 appears on one or more stacked symbol areas (in this example stacked wild 501), hot spot symbol 522 may move from a first hot spot symbol location 522A to a second hot spot symbol location and then to a third hot spot symbol location 522C. The movement pattern may be randomly determined, may move up, may move down, may move to the right, may move to the left, may move diagonally, and/or any combination thereof. Further, the final location of the hot spot may be determined by a random number generator, by a predetermined position, and/or any other placement method.

In another example, hot spot symbol 522 may continue to move to a fourth hot spot symbol location 522D, to a fifth hot spot symbol location 522E, and to a sixth hot spot symbol location 522F (see FIG. 5D). Further, hot spot symbol 522 may continue to move to a seventh hot spot symbol location 522G, to an eighth hot spot symbol location 522H, and to a ninth hot spot symbol location 522J (see FIG. 5E). In addition, hot spot symbol 522 may continue to move to a tenth hot spot symbol location 522K, an eleventh hot spot symbol location 522L, and a twelfth hot spot symbol location 522M where in may stop (see FIG. 5F).

In FIG. 5G, another illustration of hot spot game play on a gaming device is shown, according to one embodiment. In this example, hot spot symbol 522 has stopped on twelfth hot spot symbol location 522M which is a winning payline 524, therefore, a prize of 5,000 credits may be awarded to the player. In another example, a multiplier (e.g., 2 to N) may have been utilized with the winning payline. Therefore, if the winning payline generated a 3000 credit award and a 3× multiplier was generated by the hot spot symbol 522, then an award of 9000 credits would have been generated.

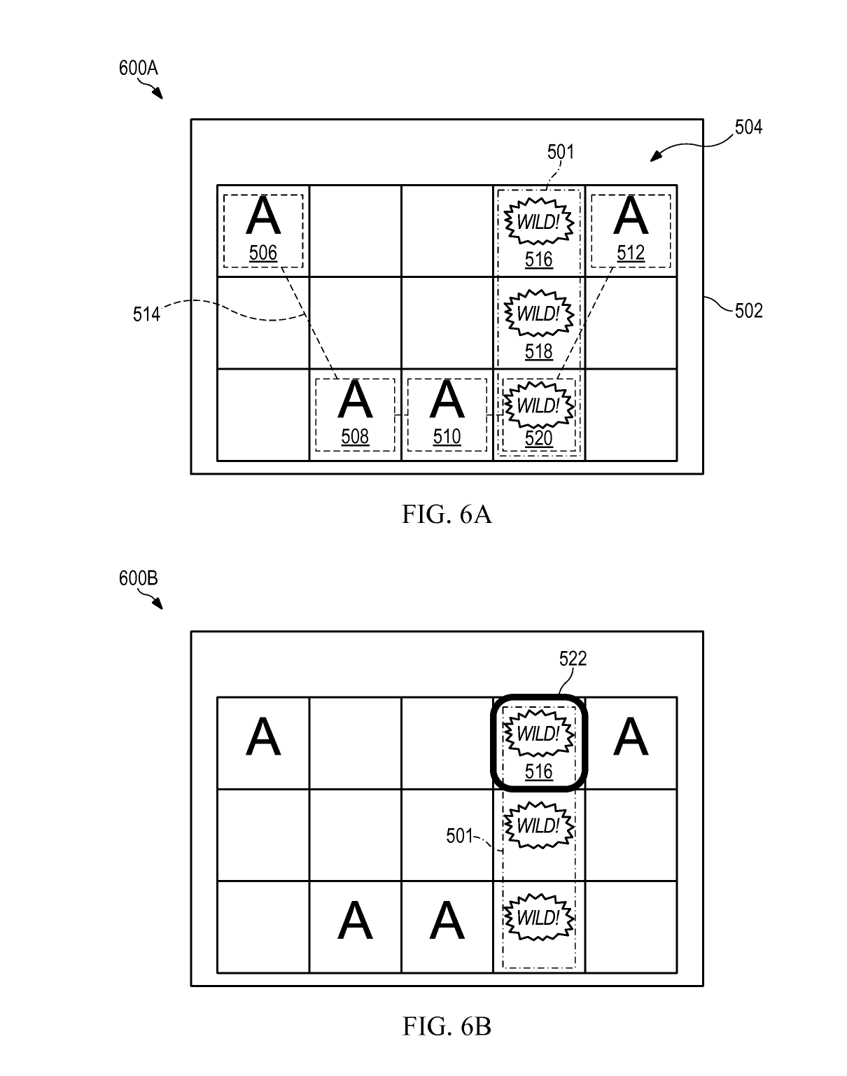

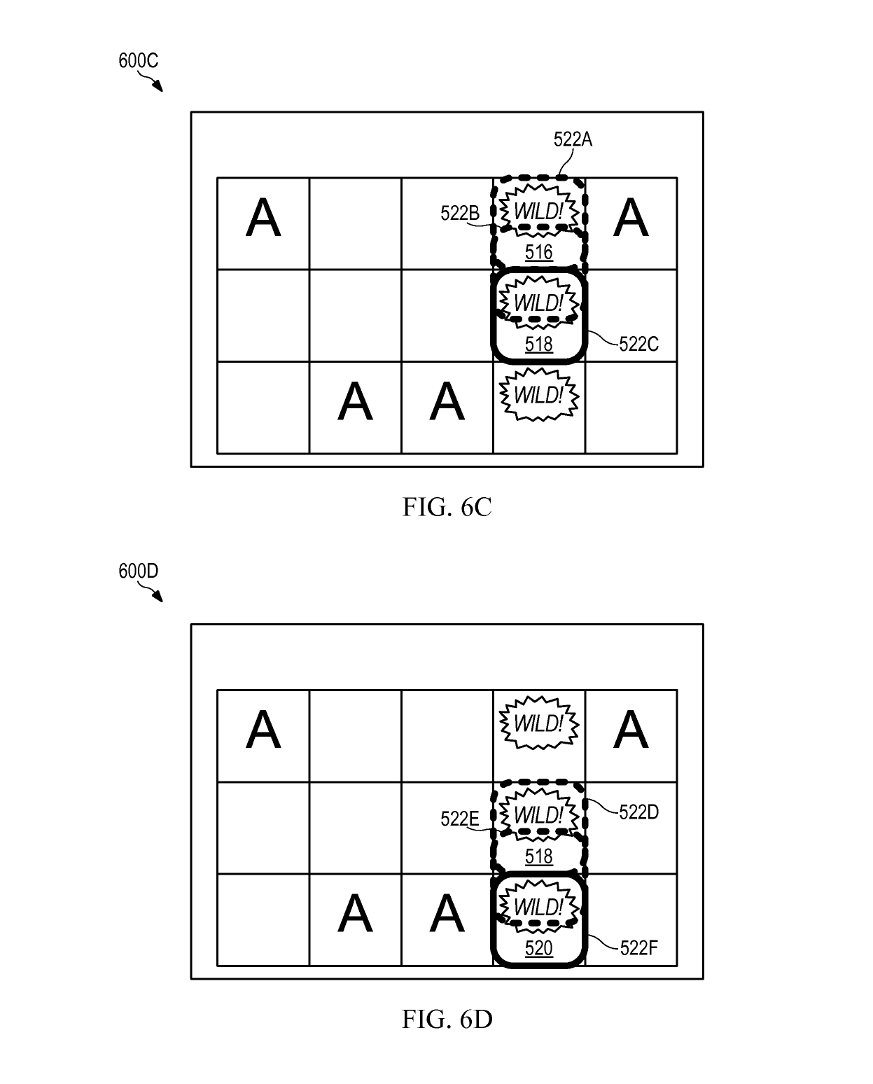

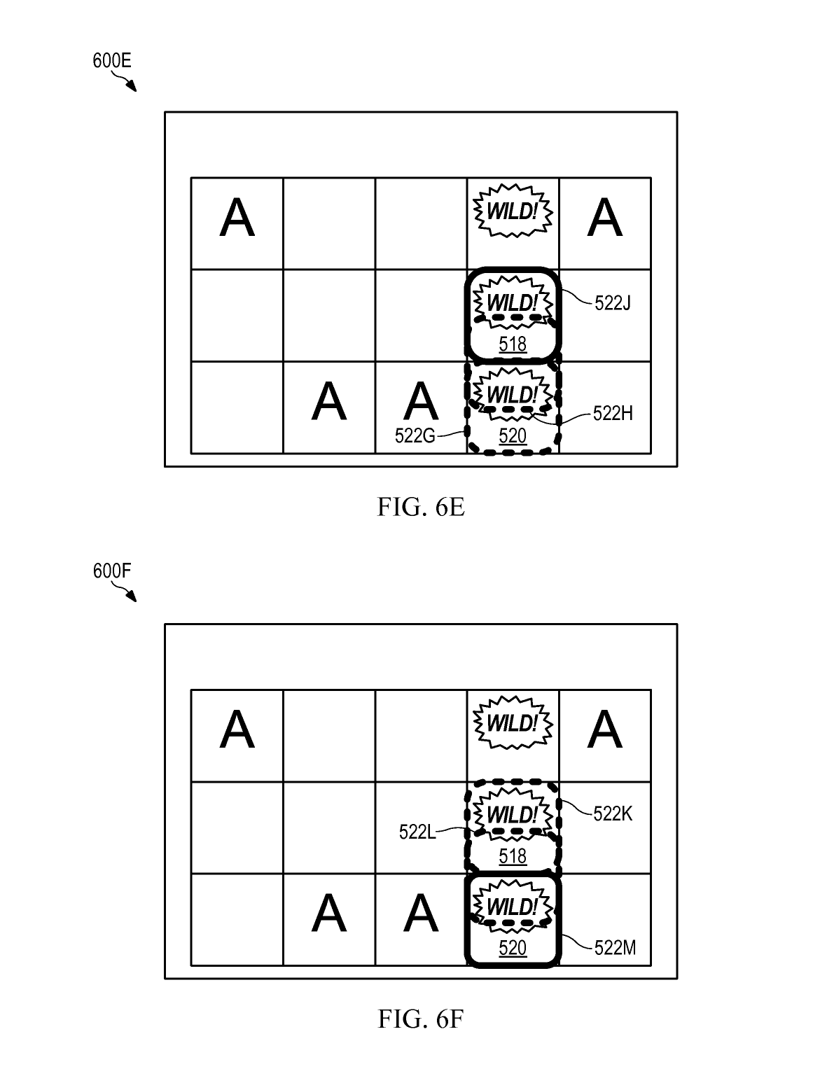

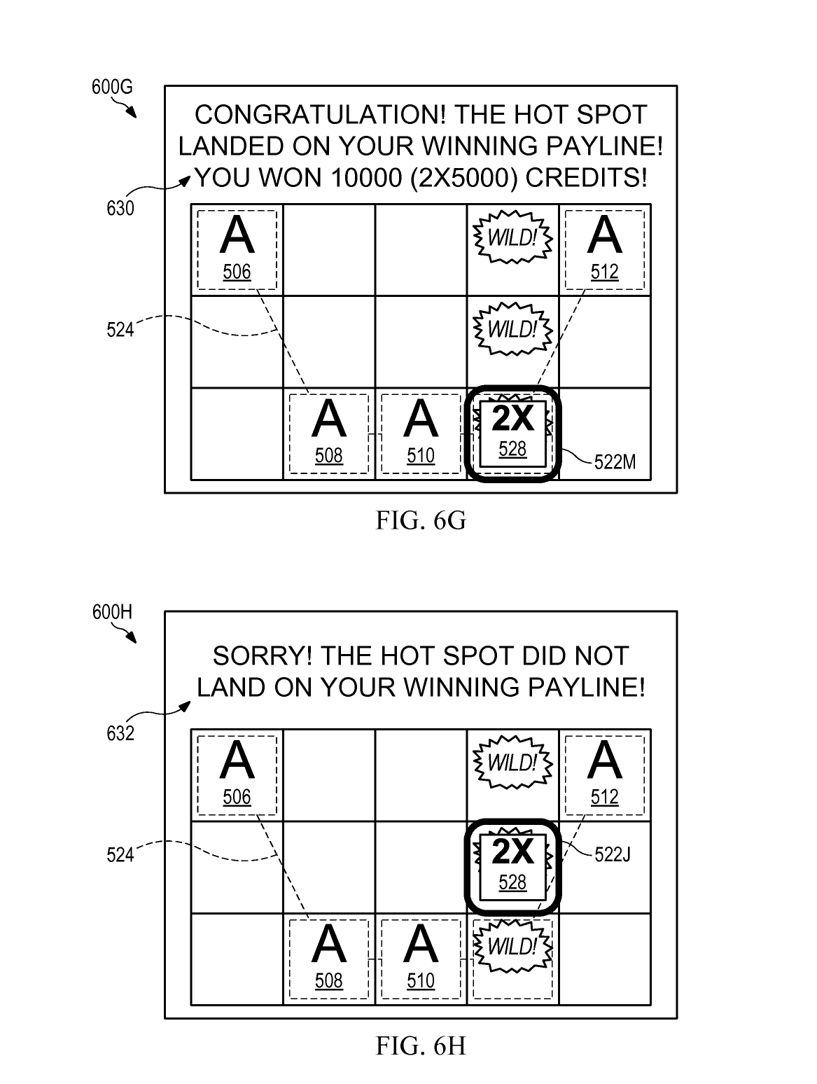

In FIG. 6A, another illustration of hot spot game play on a gaming device is shown, according to one embodiment. A third image 600A may include display screen 502, one or more reels 504, first winning payline symbol 506, second winning payline symbol 508, third winning payline symbol 510, fourth winning payline symbol 512, first payline 514, first stacked wild symbol 516, second stacked wild symbol 518, and third stacked wild symbol 520. In this example, first payline 514 is a winning payline because the four aces (e.g., first winning payline symbol 506, second winning payline symbol 508, third winning payline symbol 510, and fourth winning payline symbol 512) are matched up with a wild symbol (e.g., third stacked wild 520) to form a winning payout combination of 5 aces because the wild can be utilized as an ace. In this example, stacked wild 501 includes at least 3 wild symbols, however, any number (e.g., 1-N) of symbols may be utilized in a stacked configuration (see FIGS. 7A-7C).

In FIG. 6B, another illustration of hot spot game play on a gaming device is shown, according to one embodiment. In this example, hot spot symbol 522 may randomly be generated onto stacked wild 501. In this example, the hot spot symbol 522 may have been generated by a random number generator, a predetermined pattern, and/or any other dynamic method. Further, hot spot symbol 522 may have located on one or more stacked symbol areas (e.g., stacked wild 501, stacked aces, stacked kings, stacked bars, stacked special symbol, etc.).

In one example shown in FIG. 6C, once the hot spot symbol 522 appears on one or more stacked symbol areas (in this example stacked wild 501), hot spot symbol 522 may move from first hot spot symbol location 522A to second hot spot symbol location and then to third hot spot symbol location 522C. The movement pattern may be randomly determined, may move up, may move down, may move to the right, may move to the left, may move diagonally, and/or any combination thereof. Further, the final location of the hot spot may be determined by a random number generator, by a predetermined position, and/or any other placement method.

In another example, hot spot symbol 522 may continue to move to fourth hot spot symbol location 522D, to fifth hot spot symbol location 522E, and to sixth hot spot symbol location 522F (see FIG. 6D). Further, hot spot symbol 522 may continue to move to seventh hot spot symbol location 522G, to eighth hot spot symbol location 522H, and to ninth hot spot symbol location 522J (see FIG. 6E). In addition, hot spot symbol 522 may continue to move to tenth hot spot symbol location 522K, eleventh hot spot symbol location 522L, and twelfth hot spot symbol location 522M where in may stop (see FIG. 6F).

In FIG. 6G, another illustration of hot spot game play on a gaming device is shown, according to one embodiment. In this example, hot spot symbol 522 has stopped on twelfth hot spot symbol location 522M which is a winning payline 524, therefore, a prize of 10,000 credits may be awarded to the player because the winning payline generated a 5,000 credit award and a 2× multiplier was generated by the hot spot symbol 522, therefore an award of 10,000 credits (e.g., 5,000 credits times 2× equals 10,000 credits) would have been generated.

In another example shown in FIG. 6H, hot spot symbol 522 did not land on first payline 524, therefore, in this example no hot spot prize was generated. A message 632 may state “SORRY! THE HOT SPOT DID NOT LAND ON YOUR WINNING PAYLINE!”

In various examples, the hot spot symbol may be dynamic and may be able to move to one or more locations on the active gaming areas and/or inactive gaming areas. In various examples shown in FIGS. 7A-7C, the hot spot symbol may be static and unable to move to another symbol area location.

In FIG. 7A, another illustration of hot spot game play on a gaming device is shown, according to one embodiment. A fourth image 700A may include a first reel strip 702, a second reel strip 704, and a third reel strip 706. There may be any number (e.g., 1-N) of reel strips utilized in an electronic gaming device and/or electronic gaming system.

In one example, third reel strip 706 may include a stacked symbol area 707. Third reel strip 706 may include any number (e.g., 1-N) of stacked symbol areas (e.g., 1, 2, 3, 4, 5, 6, 7, 8, 9, 10, etc.). For example, a first stacked symbol area may have all wild symbols. Whereas, a second stacked symbol area may have all aces. Further, a third stacked symbol area may have all special symbols. In this example, stacked symbol area 707 has a first stacked symbol 708A (e.g., N, ace, wild, special symbol, etc.), a second stacked symbol 708B, a third stacked symbol 708C, a fourth stacked symbol 708D, a fifth stacked symbol 708E, a sixth stacked symbol 708F, a seventh stacked symbol 708G, and an eighth stacked symbol 708H. There may be any number (e.g., 1-N) of symbols in a stacked symbol formation.

In one example, a first hot spot symbol 710A may be located on stacked symbol area 707. In this example, first hot spot symbol 710A is located on fifth stacked symbol 708E. In another example, a second hot spot symbol 710B may be located on stacked symbol area 707. In this example, second hot spot symbol 710B is located on second stacked symbol 708B. In another example, a third hot spot symbol 710C may be located on stacked symbol area 707. In this example, third hot spot symbol 710C is located on eighth stacked symbol 708H. These hot spot symbols may be static symbols meaning that once placed on the stacked symbol area the hot spot symbols do not change locations. In addition, the number of hot spots that are utilized during game play may be dependent on the size of the wager, the time of day, a special event, player loyal card information, the duration of the playing session, any other gaming characteristic (e.g., bonus mode, etc.), and/or any combination thereof.

In another example, as the reels are spinning one or more hot spots may appear on the active gaming area and then disappear into the non-active gaming area. For example as seen in FIG. 7B, first hot spot symbol 710A and third hot spot symbol 710C are displayed in one or more active gaming areas. Whereas, second hot spot symbol 710B is not displayed on the screen because second hot spot symbol 710B is in one or more non-active gaming areas.

In another example shown in FIG. 7C, once the one or more reels has stopped spinning, then if one or more hot spots are displayed a prize may be awarded. For example, second hot spot symbol 710B is displayed in one or more active gaming areas at the end of the spin. Therefore, one or more hot spin prizes (e.g., multipliers, credits, free spins, etc.) may be generated, displayed, and awarded.

In one example, the player may utilize 3D gesturing technology discussed above to implement one or more hot spot actions and/or any game play action. For example, the player may move one or more of their body parts to initiate one or more hot spot (and/or other action) actions in one or more game plays. In one example, a person may move their arms in a downward motion to simulate and/or initiate via one or more sensors one or more hot spot actions. In another example, a person may move their right arm from above their head to below their head and/or waist to initiate an action.

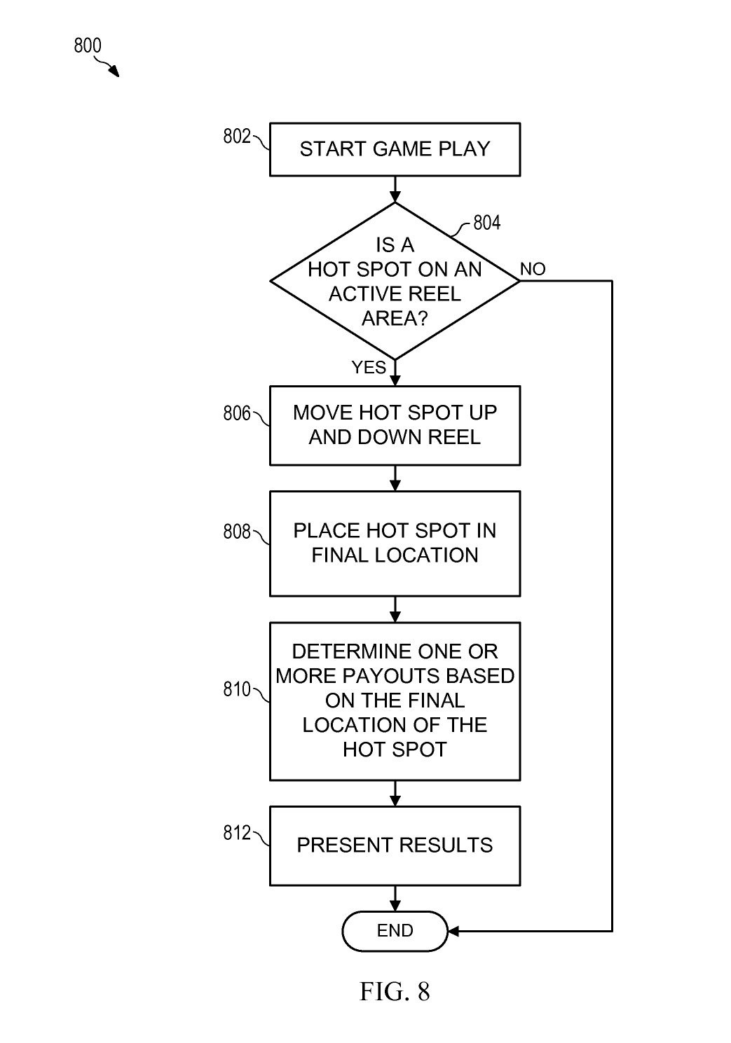

In FIG. 8, a game play flow diagram is shown, according to one embodiment. The method may include starting game play (step 802). The method may include one or more processors (via one or more electronic gaming devices and/or electronic gaming servers and/or electronic gaming systems) determining whether there is a hot spot on an active reel area (step 804). If there is no hot spot on an active reel area, then the method may end. If there is a hot spot on an active reel area, then the method may include moving the hot spot up and down the reel (step 806). The method may include placing the hot spot in a final location (step 808). The method may include determining one or more payouts based on the final location of the hot spot (step 810). The method may include presenting the game play results (step 812). In one example, all of the reels (and/or a portion of the reels) are spun where no hot spots are displayed. Once one or more of the reels have stopped spinning, the one or more hot spots may be displayed on one or more active gaming areas and/or one or more stacked symbol areas. In various examples, the one or more hot spots may move around the one or more active areas. For example, a first hot spot may move up and down vertically on a reel. In another example, a second hot spot may move across one or more reel areas. Further, a third hot spot may first move up and down vertically on a reel at first and then move horizontally across more than one reel areas and then third hot spot may move up and down vertically on a different reel than in the first movement action.

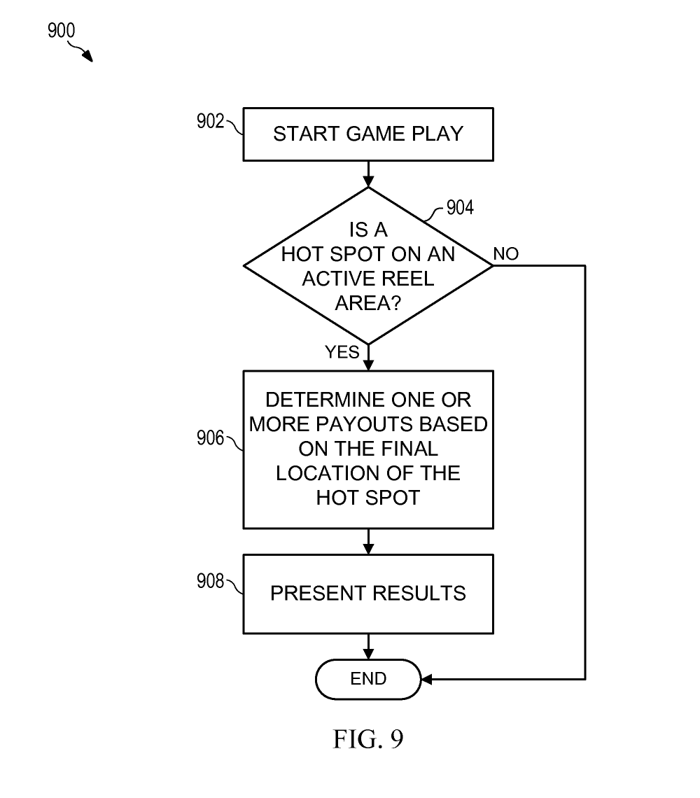

In FIG. 9, a game play flow diagram is shown, according to one embodiment. The method may include starting game play (step 902). The method may include one or more processors (via one or more electronic gaming devices and/or electronic gaming servers and/or electronic gaming systems) determining whether there is a hot spot on an active reel area (step 904). If there is no hot spot on an active reel area, then the method may end. If there is a hot spot on an active reel area, then the method may include determining one or more payouts based on a final location of the hot spot (step 906). The method may include present one or more game results (step 908). In one example, the hot spot may be displayed on a first reel after one or more of the reels (or a portion thereof) have stopped spinning. In this example, the hot spot may move up and down a first reel and when it stops the hot spot is not on a winning payline. In this example, the gaming system and/or gaming device may give the hot spot another chance by moving the hot spot to a second reel and allowing the hot spot to move up and down the second reel to potentially land on an active payline and/or winning payline.

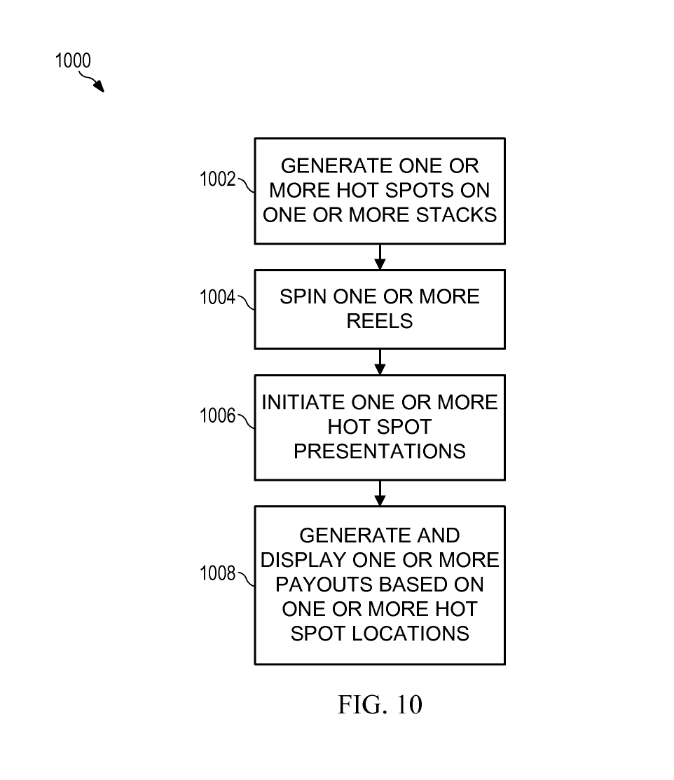

In FIG. 10, a flow diagram for game play is shown, according to one embodiment. The method may include generating one or more hot spots on one or more stacks (step 1002). The method may include spinning one or more reels (step 1004). The method may include initiating one or more hot spot presentations (step 1006). The method may include generating and displaying one or more payouts based on one or more hot spot locations (step 1008). In this static hot spot feature, one or more hot spots are placed on one or more stacked symbol areas on one or more reels before game play is initiated. These hot spots are shown going around the reels when these reels are spinning. In one example, these static hot spots do not move on the reels and/or stacked symbol areas. In another example, the static hot spot symbols may utilize one or more features of the dynamic hot spot symbols. For example, once the static hot spot symbols have appeared on one or more active areas, the static hot spot symbols may move up and down a first reel, jump to a second reel, and/or implement any other dynamic hot spot symbol characteristic.

In one example, a method may include the system and/or device generating one or more hot spot symbols. The method may include displaying one or more hot spot symbols. The method may include obtaining one or more player inputs relating to one or more hot spot symbols (e.g., hot spot symbol type—heart, the player picture, etc.). The method may include generating and/or displaying one or more presentations relating to one or more hot spot symbols. The method may include determining and displaying one or more outcomes. In another example, the player may provide input that keeps one or more hot spots on one or more stacked symbol areas and/or one or more reels.

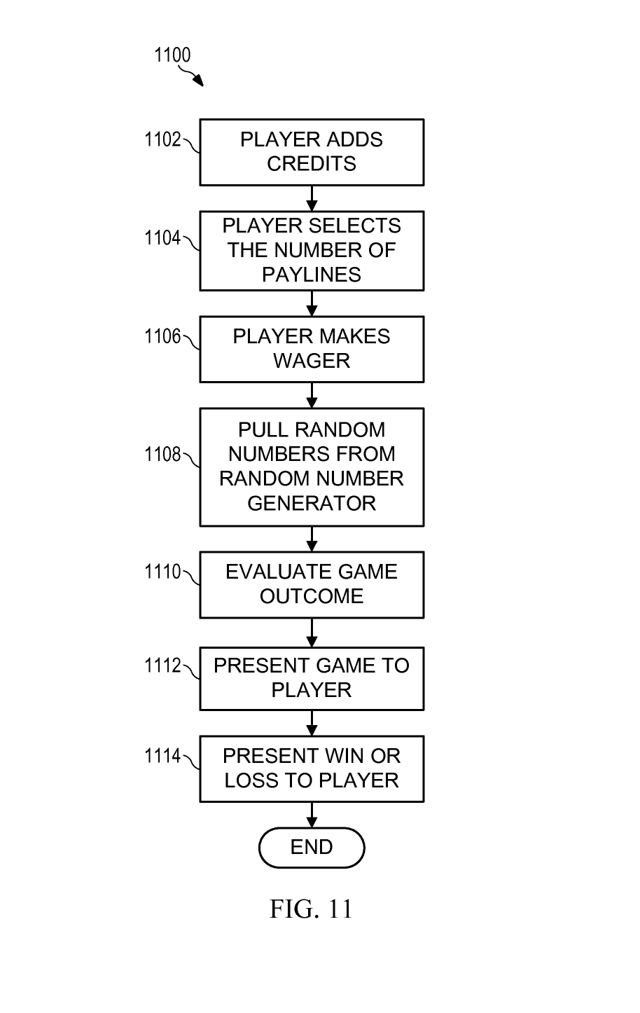

In FIG. 11, a process flowchart of one example of a primary game play 1100 on an electronic gaming system is shown, according to one embodiment. The method may include the step of a player adding credit to the electronic gaming system (step 1102). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1104, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1106, the player makes a wager on the game. In one embodiment, the wager may be a multiple of the number of paylines selected at step 1104. In another embodiment, the wager may not be a multiple of the number of paylines selected at step 1104. In a further embodiment, the wager may include a side-wager (e.g., ante bet), which may, in one example of such an embodiment, be used to make the player eligible to be awarded the extra functionality discussed above. It should be appreciated that in some embodiments, the order of steps 1104 and 1106 may be not critical, and so for example, a player can select the wager they wish to place, and then select the number of paylines they want it applied to, and that these embodiments are expressly contemplated as being within the scope of the present disclosure.

Continuing to step 1108, the gaming system pulls random numbers from a random number generator (“RNG”). In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At steps 1110 and 1112, the gaming system utilizes the random numbers pulled at step 1108 to determine the primary game symbols to display in the play of the primary game, which in turn both determines the presentation of the game to the player and evaluates the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1114, the win or loss outcome may be identified for the player. In one embodiment, this step can include additional messaging, which provides information related to the win or loss, such as why the player won or lost. In another embodiment, this step can include identification of the amount of any award earned by the player.

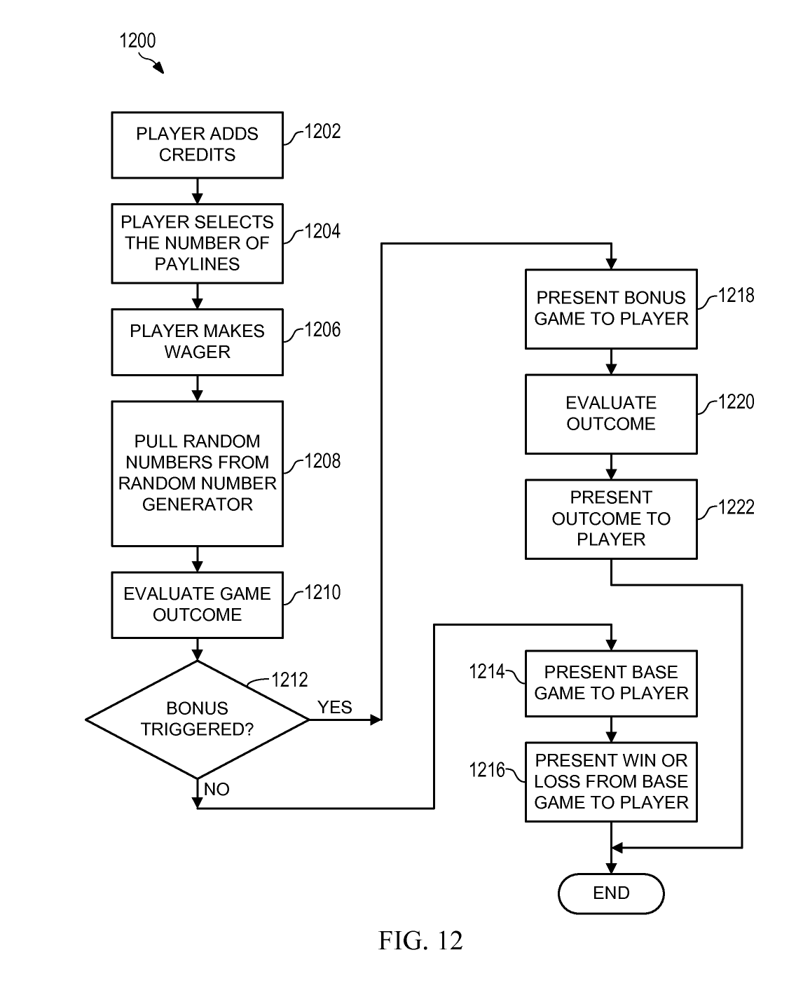

FIG. 12 is a process flowchart of one example of a combined primary and secondary game play 1200 on an electronic gaming system, according to one embodiment. The method may include the step of a player adding credit to the electronic gaming system (step 1202). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1204, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1206, the player makes a wager on the game. In one embodiment, the wager may be a multiple of the number of paylines selected at step 1204. In another embodiment, the wager may not be a multiple of the number of paylines selected at step 1204. In a further embodiment, the wager may include a side-wager, which may, in one example of such an embodiment, be used to make the player eligible to be awarded the extra functionality discussed above. It should be appreciated that in some embodiments, the order of steps 1204 and 1206 may be not critical, and so for example, a player can select the wager they wish to place, and then select the number of paylines they want it applied to, and that these embodiments may be expressly contemplated as being within the scope of the present disclosure.

Continuing to step 1208, the gaming system pulls random numbers from a random number generator “RNG”. In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At step 1210, the gaming system utilizes the random numbers pulled at step 1208 to evaluate the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1212, the gaming system determines if a secondary or bonus game may be triggered. In one embodiment, the bonus game is triggered by the display of a plurality of matching symbols at a plurality of predetermined symbol positions within a play of the primary game. In one example, the bonus game may be triggered if a plurality of matching symbols is displayed on the 2^{nd}, 3^{rd} and 4^{th} reel. In another example, the bonus game may be triggered if matching symbols are displayed on the 1^{st}, 2^{nd} and 3^{rd} reels. In a further example, the bonus game may be triggered if matching symbols occur at predetermined symbol positions that include consecutive and non-consecutive reels. In another example, a bonus game (e.g., secondary game) may be triggered in any way (e.g., one special symbols in any locations, one special symbol in one or more predetermined locations, two special symbols in any locations, two special symbols in one or more predetermined locations, three special symbols in any locations, three special symbols in one or more predetermined locations, etc.).

If it is determined that a bonus or secondary game was not triggered, the process continues to step 1214, where the base game may be fully presented to the player. As discussed above, the orders of step 1210, 1212, and 1314 can be changed without affecting the novel concepts disclosed herein.

At step 1216, the win or loss outcome of the primary game may be identified for the player. In one embodiment, this step can include additional messaging, which provides information related to the win or loss, such as why the player won or lost. In another embodiment, this step can include identification of the amount of any award earned by the player

If it is determined at step 1212 that a bonus or secondary game was triggered, then process 1200 continues to step 1218, where the secondary game may be presented to the player. As discussed above, there are numerous ways to present the secondary or bonus game to the player.

At steps 1220 and 1222, the outcome of the secondary game may be evaluated and presented to the player. In one embodiment, the outcome of the bonus game will always be a winning outcome. In another embodiment, the outcome of the secondary game will cause a significant award to be provided to the player. In one example of such an embodiment, the award may not be provided by the gaming system, as a casino operator may need to verify tax information before allowing such an award to be provided to the player. In one embodiment, instead of the process 1200 ending after step 1222, the process continues to step 1214 so as to finalize the primary game outcome presentation to the player.

One or more sensors may obtain and/or transmit one or more data points (e.g., positional data, temperature data, etc.) relating to one or more audio devices, one or more display devices, audio interface area, audio support area, audio locking device, one or more electrical attachment devices, one or more attachment areas, electronic gaming device 100, electronic gaming system 200, first audio device, wall of the audio installation area, back of the audio installation area, one or more audio interfaces, one or more electrical attachment points, an input area, one or more input devices, second audio device, front-mounted audio device, audio interface locked area, one or more electrical interconnection points, one or more electrical wires, one or more springs, one or more motors, one or more adjustable devices, and/or one or more sensors to one or more processors.

One or more sensors may obtain and/or transmit one or more data points (e.g., positional data, temperature data, etc.) relating to one or more audio devices, one or more display devices, one or more electrical wires, one or more springs, one or more motors, one or more adjustable devices, and/or one or more sensors to one or more processors.

In one embodiment, the electronic gaming device may include a plurality of reels. The one or more paylines may be formed on at least a portion of the plurality of reels. The electronic gaming device may include a memory.

In one embodiment, the electronic gaming device may include a plurality of reels. The plurality of reels may include one or more areas. The electronic gaming device may include a processor and a memory. The memory may include one or more hot spot feature structures. The processor may generate one or more symbols to be located in the one or more areas. The processor may move a first hot spot to a first replacement location based on the first replacement location having a top award amount.

In another example, the processor may initiate a base game, a bonus game, and a hot spot game. In another embodiment, the method of providing game play via an electronic gaming device may include: initiating via one or more processors a base game; initiating via the one or more processors a hot spot game; and/or moving via the one or more processors one or more hot spots to one or more replacement locations.

In one embodiment, an electronic gaming device may include a plurality of reels where the plurality of reels includes one or more areas. The electronic gaming device may include a memory and a processor. The memory may include one or more hot spot feature structures. The processor may generate one or more symbols to be located in the one or more area and/or generate one or more hot spot symbols.

In another example, the processor may: obtain one or more inputs relating to the one or more hot spot symbols; generate a first payout based on the one or more symbols; generate one or more hot spot symbols based on the one or more inputs relating to the one or more hot spot symbols; generate a second payout based on at least a portion of the one or more symbols and the one or more hot spot symbols; obtain one or more hot spot inputs relating to the one or more hot spot symbols via at least one of a 3D sensor and a 3D device; generate a first payout based on the one or more symbols and to generate one or more hot spot symbols based on the one or more hot spot inputs relating to the one or more hot spot symbols; generate a second payout based on at least a portion of the one or more symbols and the one or more hot spot symbols; generate and display a mystery symbol; obtain one or more inputs related to the mystery symbol; and/or reveal at least two levels (and/or any level amount (e.g., 1-N)) of the mystery symbol based on at least two inputs (and/or any input amount (e.g., 1-N)) relating to the mystery symbol.

In another embodiment, a method of providing game play via an electronic gaming device may include: initiating via one or more processors a base game; generating via the one or more processors one or more hot spot symbols; displaying the one or more hot spot symbols; obtaining one or more inputs relating to the one or more hot spot symbols; generating a first payout based on the one or more symbols and to generating one or more hot spot symbols based on the one or more inputs relating to the one or more hot spot symbols; generating a second payout based on at least a portion of the one or more symbols and the one or more hot spot symbols; and/or obtaining one or more hot spot inputs relating to the one or more hot spot symbols via at least one of a 3D sensor and a 3D device.

In another example, an electronic gaming system may include a server which may include a server processor and a server memory. The system may include a display device including a plurality of reels where the plurality of reels includes one or more areas. The server memory may include one or more hot spot feature structures. The server processor may generate one or more symbols to be located in the one or more areas and/or generate one or more hot spot symbols.

In another example, the server processor may: obtain one or more inputs relating to the one or more hot spot symbols; generate a first payout based on the one or more symbols and to generate one or more hot spot symbols based on the one or more inputs relating to the one or more hot spot symbols; generate a second payout based on at least a portion of the one or more symbols and the one or more hot spot symbols; and/or obtain one or more hot spot inputs relating to the one or more hot spot symbols via at least one of a 3D sensor and a 3D device.

In another example, any number of symbols on any number of reels may randomly start pulsating; with the word “Hot spot” hovering over them (and/or any other word and/or any other image, and/or any other symbol). The players may then make a hot spot gesture over each of the pulsating symbols to reveal one or more new symbols underneath. Further, these symbols may complete one or more pay lines that may not have otherwise occurred. In various examples, this may occur in the bonus game, base game, and/or tournament game mode to reveal new symbols that may complete one or more pay lines, generate multipliers, generate wilds, generate expanding wilds, generate scatters, generate free spins, generate another prize (e.g., free dinner, free concert, etc.), generate another hot spot level (e.g., level 1 after one hot spot action which may equal prize 1, level 2 after two hot spot actions which may equal prize 2, level 3 after three hot spot actions which may equal prize 3, etc.—in another example, level 1 after two hot spot actions which may equal prize 2, level 2 after five hot spot actions which may equal prize 4, level 3 after 10 hot spot actions which may equal prize 7, etc.), and/or generate credits.

In one example, the reels may spin and stop where one or more hot spots randomly appear on one or more stacked symbol arrangements. In this example, the one or more hot spots may start to move along the one or more stacked symbol arrangements. In various examples, the movement may be up and down, side to side, up and to the left side, in a circular direction, in a square shape, in an L shape, any movement pattern, and/or any combination thereof. In this example, when the hot spot lands on a winning payline a multiplier may be generated for this winning payline. In another example, when the hot spot lands on a winning payline a prize (e.g., free spins, credits, etc.) may be generated. In another example, if the hot spot does not land on a winning payline, then no prize may be generated. In another example, if the hot spot does not land on a winning payline, a secondary prize (e.g., small credit prize, credits, free spins, smaller multiplier, etc.) may be generated. In another example, if the hot spot does not land on a winning payline, a prize (e.g., credits, multiplier, free spins, etc.) may still be generated. In another example, the number of hot spots may dependent on the amount wagered and/or any other game characteristics. For example, if a player bets one credit per payline, then no hot spots may be generated. When the player bets two credits per payline, one hot spot may be generated. When the player bets four credits per payline, two hot spots may be generated. When the player makes a maximum bet, then three hot spots may be generated. In another example, the player may be required to have a maximum bet for any hot spots to be generated. In another example, the hot spot generation may be at least partially based on a loyal card rating and/or any other characteristic of the player (e.g., length of play, length of time with a player's card, amount won and/or lost, frequency of visits to the casino, etc.).

In another example, one or more streaming stacks may have one or more static hot spots. In the previous example, the one or more hot spots were dynamic hot spots because there initial location was randomly selected and these hot spots moved inside of the stack. Whereas, the static hot spots are placed in an initial position on the symbol stack and may not move. In various examples seen in FIGS. 7A-7C, one or more hot spots are located on the streaming stack (e.g., wild, ace, etc.). In this example, the hot spot may be visible on the reel which may cause player anticipation and enhanced player game satisfaction. In this example, when the one or more reels stops and the one or more hot spots also stop in an active gaming area, then a prize (e.g., multiplier, credits, free spins, etc.) is generated, revealed, and/or displayed.

In another example, one or more hot spot gaming features may be where individual and/or multiple hot spots appear (e.g., randomly, statically, dynamically, and/or any combination thereof) within one or more streaming stacks in a base game, a bonus game, a tournament game mode, and/or any combination thereof to reveal one or more prizes (e.g., multiplier, free spins, credits, etc.).

In one example, a hot spot may randomly appear on a reel filled with streaming stacks after the streaming stack has landed. In another example, the hot spot may remain in the stack constantly. The streams and hot spot(s) do not necessarily have to be a part of a winning pay line for the feature to appear. In one example, after the streaming stacks land on the reels, an individual symbol area may be randomly highlighted and/or animated up and down that area and/or reels before stopping on an individual space. In one example, the hot spot(s) may then display an award amount (e.g., multiplier amount, credit amount, free spin amount, etc.). In one example, the multiplier amount may or may not be on a winning pay line and the multiplier may only count for a winning pay line which it is a part of. In another example, the hot spot may be seen on the reels as the reels spin by. If the hot spot happens to land on the reel, the hot spot may display a prize (e.g., multiplier, credits, free spins, etc.) which may be for that potential payline and/or as a general award (e.g., does not need to be on a payline to be awarded. In various examples, any number (e.g., 1-N) of hot spots may be utilized and the number of hot spots may depend on a player's wager. For example, the player would have a chance to get more hot spots by increasing their bet level.

In one embodiment, the electronic gaming device may include a plurality of reels, a memory, and a processor. The plurality of reels may include one or more areas. The memory may include one or more hot spot feature structures. The processor may generate one or more hot spot symbols to be located in one or more reels. The processor may generate one or more awards based on one or more hot spot symbol locations.

In another example, at least (or one or more of the) one of the one or more hot spot symbols is a static hot spot symbol which is anchored to one or more stacked symbol areas. In another example, at least (or one or more of the) one of the one or more hot spot symbols is a dynamic hot spot symbol which appears once the reels stop spinning. Further, the dynamic hot spot symbol may move around the one or more stacked symbol areas after the reels have stopped spinning. In addition, the dynamic hot spot symbol may stop on a winning payline and may generate an additional award based on the dynamic hot spot symbol location. Further, the dynamic hot spot symbol may stop on a non-winning payline and may not generate an additional award based on the dynamic hot spot symbol location. In another example, the dynamic hot spot symbol may stop on a non-winning payline and may generate an incremental award based on the dynamic hot spot symbol location. In addition, the incremental award is a small prize.

In another embodiment, a method of providing game play via an electronic gaming device may include: initiating via one or more processors a base game; generating via the one or more processors one or more hot spot symbols; displaying the one or more hot spot symbols; and/or generating one or more payouts based on one or more hot spot symbol locations.

Further, at least one of the one or more hot spot symbols is a static hot spot symbol which is anchored to one or more stacked symbol areas. In addition, at least one of the one or more hot spot symbols is a dynamic hot spot symbol which appears once the reels stop spinning. In another example, the dynamic hot spot symbol moves around the one or more stacked symbol areas after the reels have stopped spinning. In one example, the dynamic hot spot symbol moves around the one or more stacked symbol areas after the reels have stopped spinning. In addition, the dynamic hot spot symbol stops on a winning payline and generates an additional award based on the dynamic hot spot symbol location

In another embodiment, an electronic gaming system may include a server including a server processor and a server memory a display device including a plurality of reels. The plurality of reels may include one or more areas. The server memory may include one or more hot spot feature structures. The server processor may generate one or more hot spot symbols to be located in one or more reels. The server processor may generate one or more awards based on one or more hot spot symbol locations.

In another example, at least (or one or more of the) one of the one or more hot spot symbols is a static hot spot symbol which is anchored to one or more stacked symbol areas. In another example, at least (or one or more of the) one of the one or more hot spot symbols is a dynamic hot spot symbol which appears once the reels stop spinning. Further, the dynamic hot spot symbol may move around the one or more stacked symbol areas after the reels have stopped spinning. In addition, the dynamic hot spot symbol may stop on a winning payline and may generate an additional award based on the dynamic hot spot symbol location. Further, the dynamic hot spot symbol may stop on a non-winning payline and may not generate an additional award based on the dynamic hot spot symbol location. In another example, the dynamic hot spot symbol may stop on a non-winning payline and may generate an incremental award based on the dynamic hot spot symbol location. In addition, the incremental award is a small prize.

Gaming system may be a “state-based” system. A state-based system stores and maintains the system's current state in a non-volatile memory. Therefore, if a power failure or other malfunction occurs, the gaming system will return to the gaming system's state before the power failure or other malfunction occurred when the gaming system is powered up.

State-based gaming systems may have various functions (e.g., wagering, payline selections, reel selections, game play, bonus game play, evaluation of game play, game play result, steps of graphical representations, etc.) of the game. Each function may define a state. Further, the gaming system may store game histories, which may be utilized to reconstruct previous game plays.

A state-based system is different than a Personal Computer (“PC”) because a PC is not a state-based machine. A state-based system has different software and hardware design requirements as compared to a PC system.

The gaming system may include random number generators, authentication procedures, authentication keys, and operating system kernels. These devices, modules, software, and/or procedures may allow a gaming authority to track, verify, supervise, and manage the gaming system's codes and data.

A gaming system may include state-based software architecture, state-based supporting hardware, watchdog timers, voltage monitoring systems, trust memory, gaming system designed communication interfaces, and security monitoring.

For regulatory purposes, the gaming system may be designed to prevent the gaming system's owner from misusing (e.g., cheating) via the gaming system. The gaming system may be designed to be static and monolithic.

In one example, the instructions coded in the gaming system are non-changeable (e.g., static) and are approved by a gaming authority and installation of the codes are supervised by the gaming authority. Any change in the system may require approval from the gaming authority. Further, a gaming system may have a procedure/device to validate the code and prevent the code from being utilized if the code is invalid. The hardware and software configurations are designed to comply with the gaming authorities' requirements.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed. Further, one or more gaming options may be Internet based gaming options. Therefore, all of the examples and/or embodiments may be utilized via an Internet based gaming system.

1. An electronic gaming device comprising:
a plurality of reels, the plurality of reels including one or more areas;
a memory, the memory including one or more hot spot feature structures;
a processor configured to generate one or more hot spot symbols to be located in one or more reels, the processor configured to generate one or more awards based on one or more hot spot symbol locations.

2. The electronic gaming device of claim 1, wherein at least one of the one or more hot spot symbols is a static hot spot symbol which is anchored to one or more stacked symbol areas.

3. The electronic gaming device of claim 1, wherein at least one of the one or more hot spot symbols is a dynamic hot spot symbol which appears once the reels stop spinning.

4. The electronic gaming device of claim 3, wherein the dynamic hot spot symbol moves around the one or more stacked symbol areas after the reels have stopped spinning.

5. The electronic gaming device of claim 3, wherein the dynamic hot spot symbol stops on a winning payline and generates an additional award based on the dynamic hot spot symbol location.

6. The electronic gaming device of claim 3, wherein the dynamic hot spot symbol stops on a non-winning payline and does not generate an additional award based on the dynamic hot spot symbol location.

7. The electronic gaming device of claim 3, wherein the dynamic hot spot symbol stops on a non-winning payline and generates an incremental award based on the dynamic hot spot symbol location.

8. The electronic gaming device of claim 7, wherein the incremental award is a small prize.

9. A method of providing game play via an electronic gaming device comprising:
initiating via one or more processors a base game;
generating via the one or more processors one or more hot spot symbols;
displaying the one or more hot spot symbols; and
generating one or more payouts based on one or more hot spot symbol locations.

10. The method of claim 9, wherein at least one of the one or more hot spot symbols is a static hot spot symbol which is anchored to one or more stacked symbol areas.

11. The method of claim 9, wherein at least one of the one or more hot spot symbols is a dynamic hot spot symbol which appears once the reels stop spinning.

12. The method of claim 11, wherein the dynamic hot spot symbol moves around the one or more stacked symbol areas after the reels have stopped spinning.

13. The method of claim 11, wherein the dynamic hot spot symbol moves around the one or more stacked symbol areas after the reels have stopped spinning.

14. The method of claim 11, wherein the dynamic hot spot symbol stops on a winning payline and generates an additional award based on the dynamic hot spot symbol location

15. An electronic gaming system comprising:
a server including a server processor and a server memory;
a display device including a plurality of reels, the plurality of reels including one or more areas;
the server memory including one or more hot spot feature structures; and
the server processor is configured to generate one or more hot spot symbols to be located in one or more reels, the server processor configured to generate one or more awards based on one or more hot spot symbol locations.

16. The electronic gaming system of claim 15, wherein at least one of the one or more hot spot symbols is a static hot spot symbol which is anchored to one or more stacked symbol areas.

17. The electronic gaming system of claim 15, wherein at least one of the one or more hot spot symbols is a dynamic hot spot symbol which appears once the reels stop spinning.

18. The electronic gaming system of claim 17, wherein the dynamic hot spot symbol moves around the one or more stacked symbol areas after the reels have stopped spinning.

19. The electronic gaming system of claim 17, wherein the dynamic hot spot symbol stops on a winning payline and generates an additional award based on the dynamic hot spot symbol location.

20. The electronic gaming system of claim 17, wherein the dynamic hot spot symbol stops on a non-winning payline and does not generate an additional award based on the dynamic hot spot symbol location.
